(19) United States
(12) Patent Application Publication
(10) Pub. No.: US 2009/0033792 A1
(43) Pub. Date: Feb. 5, 2009

(54) Image Processing Apparatus And Method, And Electronic Appliance

(75) Inventors: Hiroshi KANO, Kyotanabe City (JP); Akihiro MAENAKA, Kadoma City (JP); Norikazu TSUNEKAWA, Amagasaki City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 12/183,554

(22) Filed: Jul. 31, 2008

(30) Foreign Application Priority Data
Aug. 2, 2007 (JP) JP2007-201860

(51) Int. Cl. H04N 7/01

(52) U.S. Cl. 348/441; 348/E07.001

(57) ABSTRACT

An image processing apparatus includes a high resolution processing portion for generating a high-resolution image from a first low-resolution image to be a datum frame and M (M is an integer of one or larger) second low-resolution images, the high-resolution image having a higher resolution than the low-resolution images, and a region cutting out portion for setting a first target region in an image region of the first low-resolution image and for setting a second target region in an image region of the second low-resolution image. The high resolution processing portion calculates a pixel value of a region corresponding to the first target region in an image region of the high-resolution image based on pixel values of the first and the second target regions set by the region cutting out portion. The region cutting out portion scans the position of the first target region to be set in the first low-resolution image and sets the second target region at a position corresponding to the position of the first target region after the scan every time when the high resolution processing portion calculates the pixel value of the high-resolution image.

This nonprovisional application claims priority under 35 U.S.C. § 119(a) on Patent Application No. 2007-201860 filed in Japan on Aug. 2, 2007, the entire contents of which are hereby incorporated by reference.

### BACKGROUND OF THE INVENTION

1. Field of the Invention

The present invention relates to an image processing apparatus and an image processing method, which are used for generating a high-resolution image from a plurality of low-resolution images, in particular. Also, the present invention relates to an electronic appliance utilizing the image processing apparatus.

2. Description of Related Art

Recently, image sensing apparatuses for obtaining digital images by using a solid-state image sensing device such as a CCD (Charge Coupled Device) or a CMOS (Complimentary Metal Oxide Semiconductor) image sensor as well as display devices for displaying the digital images have become widely available along with development of various digital techniques. The image sensing apparatus is, for instance, a digital still camera or a digital video camera while the display device is, for instance, a liquid crystal display or a plasma television set. As for the image sensing apparatus and the display device, an image processing technique is proposed, in which a plurality of digital images obtained at different time points are used for converting a resolution of the images into higher one. Hereinafter, this conversion is referred to as a high resolution conversion.

The image processing technique with the high resolution conversion is used for generating primary color images of R (red), G (green) and B (blue) having the same resolution as a CFA (Color Filter Array) image from the CFA image obtained by using a single solid-state image sensing device having a micro primary color filter of R, G and B or the like arranged in a tessellated manner, or for generating a CFA image having a higher resolution. The digital images including the CFA image are generated by obtaining image information of subject images at digitized sampling positions. If the sampling positions are shifted from each other between different frames, a plurality of CFA images of different sampling positions among frames are obtained. As an example of such a plurality of CFA images, FIG. 25 shows three CFA images. Handling these three CFA images as low-resolution images, so that the high resolution conversion can be performed by utilizing the three CFA images.

On this occasion, an interpolation process based on the high resolution conversion is utilized so that an R image made up of only R signals, a G image made up of only G signals and a B image made up of only B signals can be generated as shown in FIG. 26. Each of these R, G and B images has pixels of the same pixel number as that of one CFA image. Pixel values of R pixels in the three CFA images shown in FIG. 25 are used for the high resolution conversion so that the R image shown in FIG. 26 is obtained. Pixel values of G pixels in the three CFA images shown in FIG. 25 are used for the high resolution conversion so that the G image shown in FIG. 26 is obtained. Pixel values of B pixels in the three CFA images shown in FIG. 25 are used for the high resolution conversion so that the B image shown in FIG. 26 is obtained.

In addition, it is possible to perform the high resolution conversion so that a positional relationship among R, G and B pixels in the CFA image is maintained as it is. Thus, it is possible to generate the CFA image as the high-resolution image having an increased pixel number as shown in FIG. 27. More specifically, using the pixel values of R, G and B pixels in the three CFA images shown in FIG. 25 for performing the high resolution conversion, it is possible to obtain the pixel values of R, G and B pixels in the high-resolution image shown in FIG. 27.

As a process for realizing the high resolution conversion described above, a super-resolution process is proposed, in which a plurality of low-resolution images having position errors (displacements) from each other are used for estimating one high-resolution image. As one type of the super-resolution process, there is a one called a reconstruction type. The reconstruction type super-resolution process includes estimating a process in which the low-resolution image is generated from the high-resolution image, and then generating the high-resolution image by performing a process corresponding to a reverse process of the estimated process on the obtained low-resolution image.

In a method other than the reconstruction type method, a uniformly sampled high-resolution image is obtained by resampling based on a plurality of low-resolution images having a nonuniform sampling period among different frames, and then blur generated in the obtained high-resolution image is removed by using an image restoring process or the like. In this other method, pixel values at a sampling point in each of the plurality of low-resolution images are used for calculating the high resolution conversion, so that a weighting factor is set with respect to each of the pixel values in accordance with a distance between the resampling point in the high-resolution image and the corresponding sampling point in the low-resolution image. Then, a weighted average of pixel values in the plurality of low-resolution images that are used for calculating the high resolution conversion is calculated in accordance with the set weighting factor, so that a pixel value of the resampling point in the high-resolution image is obtained.

For instance, as shown in FIG. 28, in order to obtain a pixel value V_{H} of a pixel position α_{H} as the resampling point of the high-resolution image, a weighted average of pixel values v1 to v8 of pixel positions β1 to β8 is calculated based on the plurality of low-resolution images. The pixel positions β1 to β8 indicate positions of the sampling points (nonuniform sampling points) near the pixel position α_{H} in the plurality of low-resolution images. More specifically, weighting factors w1 to w8 to be multiplied to the pixel values v1 to v8 are set based on distances L1 to L8 between the pixel position α_{H} and each of the pixel positions β1 to β8 on the image, and the pixel value V_{H} of the pixel position α_{H} is calculated in accordance with the equation (A1) below. Note that concerning a noted pixel, the pixel value means information indicating luminance and color (or information indicating luminance or color) of the noted pixel.

$${V}_{H} = {\sum }_{i = 1}^{8} wi \times vi \qquad ( A 1 )$$

In this case, the weighting factors w1 to w8 are calculated so as to have a low pass characteristic. For instance, values of the weighting factors w1 to w8 are varied exponentially in accordance with the distances L1 to L8. Although blur may occur due to the weighted average, the blur can be cancelled by the image restoring process performed after the weighted average.

In contrast, as to a repeating computational algorithm that is a calculation method for realizing the super-resolution process by the reconstruction type described above, an initial high-resolution image is estimated first from the plurality of low-resolution images in STEP 1. Next, in STEP 2, the original low-resolution images constructing the high-resolution image are estimated by reverse conversion based on the current high-resolution image. After that, in STEP 3, the original low-resolution images are compared with the estimated low-resolution images, and a new high-resolution image is estimated so that a difference between pixel values of the compared images at each pixel position becomes small based on a result of the comparison in STEP 4. The process from the STEP 2 to the STEP 4 is performed repeatedly so that the difference converges, and thus the high-resolution image becomes close to an ideal one.

As the super-resolution process method that can be realized by the repeating calculation (repeating computational algorithm), some methods are proposed, including an ML (Maximum-Likelihood) method, an MAP (Maximum A Posterior) method, a POCS (Projection Onto Convex Set) method, an IBP (Iterative Back Projection) method and the like. In the ML method, the square errors between the pixel values of the low-resolution images estimated from the high-resolution image and the pixel values of the real low-resolution images are taken as an evaluation function, and the high-resolution image that minimizes this evaluation function is generated. In other words, the super-resolution process of this ML method is a process based on maximum likelihood estimation.

In the MAP method, probability information of the high-resolution image is added to the square errors between the pixel values of the low-resolution images estimated from the high-resolution image and the pixel values of the actual low-resolution images, and the sum is taken as the evaluation function. Then, the high-resolution image is generated so as to minimize the evaluation function. In other words, the MAP method obtains an optimal high-resolution image by estimating the high-resolution image for maximizing occurrence probability in a post probability distribution based on prescient information. Note that the prescient information here is one with respect to the high-resolution image.

In the POCS method, simultaneous equations are made with respect to the pixel values of the high-resolution image and the pixel values of the low-resolution images. Then, the simultaneous equations are solved sequentially, so that the optimal values of the pixel values of the high-resolution image are obtained for generating the high-resolution image. In the IBP method, the errors between the low-resolution images estimated from the high-resolution image calculated temporarily and actually obtained low-resolution images are reversely projected onto the temporary high-resolution image in a repeated manner (corresponding to a repeated reverse projection method), so as to obtain the high-resolution image with high definition.

As a method for obtaining a high-resolution image by using such the super-resolution process, a conventional method 1 is also proposed as described below. In the conventional method 1, an image region of the high-resolution image is divided into predetermined small regions. Then, a mean value of pixel values in the low-resolution image included in the small region is calculated for each of the small regions, so that pixel values of the small region is represented by the mean value (in other words, the mean value is used as a representative value of the pixel values in the small region) for speeding up of the super-resolution process. More specifically, it is necessary for other conventional methods different from the conventional method 1 to perform the estimation operation with respect to every observed pixel included in the small region for estimating the high-resolution image from the low-resolution image. In contrast, the super-resolution process according to the conventional method 1 requires one time of estimation operation for each small region. Thus, an operation quantity of the calculation process necessary for estimating the high-resolution image can be reduced, so that the super-resolution process can be sped up.

In addition, a super-resolution process method (hereinafter referred to as a conventional method 2) is also proposed, in which the evaluation function corresponding to the conventional method 1 is utilized for speeding up the calculation of the evaluation function and a differentiation calculation with respect to the high-resolution image of the evaluation function. In the conventional method 2, four types of images are used in the evaluation function and a differential equation of the evaluation function so as to speed up the operation. The four types of images include a high-resolution image obtained by the super-resolution process, an average observation image obtained by approximating pixel positions with nonuniform intervals viewed upon alignment of the plurality of low-resolution images to be pixel positions of the high-resolution image, a PSF image made up of a “point spread function” that is used for multiplication with the high-resolution image, and a weight image having pixel values as pixel numbers obtained by the approximation for each pixel position when the average observation image is formed.

Furthermore, the MAP method is regarded to provide the most powerful process with highest precision in the super-resolution process of the reconstruction type that is adopted in the conventional methods 1 and 2. The MAP method will be described in detail as follows. When each process of the above-mentioned STEP 1 to STEP 4 is performed, the evaluation function is used for estimating the low-resolution images from the high-resolution image, so that a calculation process for calculating an update quantity of the high-resolution image is performed. This evaluation function will be described mainly for the description of the MAP method.

In the super-resolution process based on the MAP method, a plurality of low-resolution images obtained by actual shooting or the like (hereinafter may be referred to as an actual low-resolution image in particular) are used for estimating one high-resolution image. All the pixel values of the high-resolution image to be estimated expressed by a vector are represented by “x”, all the pixel values of the plurality of actual low-resolution images that is used for estimating one high-resolution image and are expressed by a vector are represented by “y”.

Therefore, if one high-resolution image is made up of 400 pixels for instance, the vector x becomes a 400-dimensional vector, and values of 400 elements constituting the vector x are indicated by 400 pixel values forming the high-resolution image. In addition, if four actual low-resolution images are used for estimating one high-resolution image and each of the actual low-resolution images is made up of 100 pixels for instance, the vector y becomes a 400-dimensional vector and values of 400 elements constituting the vector y are indicated by total 400 pixel values of four actual low-resolution images. The vector x is formed by listing pixel values of the estimated high-resolution image, so “x” can be also referred to as pixel values (a pixel value group) of the high-resolution image. Similarly, the vector y is formed by listing pixel values of the plurality of actual low-resolution images, so “y” can be also referred to as pixel values (a pixel value group) of the actual low-resolution image.

When the reverse conversion in the above-mentioned STEP 2 is performed, a plurality of processes including the first to the third processes below are performed in turn. The first process is an appropriate low pass filter process performed on the high-resolution image, the second process is a process for performing rotation and parallel displacement corresponding to a position error between the low-resolution images, and the third process is a thinning process from the pixel number of the high-resolution image to the pixel number of the low-resolution image. Note that the low-resolution image estimated by the reverse conversion performed on the high-resolution image is also referred to as an estimated low-resolution image in particular.

Characteristic of the process that is a combination of the above-mentioned first to third processes is expressed by a matrix A. More specifically, a relationship between the pixel value y of the obtained actual low-resolution image and the pixel value x of the estimated high-resolution image is expressed by the matrix equation (A2) below. Note that NOIZE in the equation (A2) indicates noise generated when the low-resolution image is obtained.

y=Ax+NOIZE (A2)

In the MAP method, an evaluation function E[x] expressed by the equation (A3) below is defined based on a square error between the estimated low-resolution image expressed by Ax and the actual low-resolution image expressed by y, and the high-resolution image (i.e., x) such that the evaluation function E[x] is minimized is calculated.

E[x]=∥y−Ax∥²+f(x) (A3)

A square error between a pixel value of the estimated low-resolution image and a pixel value of the actual low-resolution image is determined for each pixel position, and a total sum of the square errors determined for individual pixel positions corresponds to the first term ∥y−Ax∥² in the right-hand side of the equation (A3). The second term f(x) in the right-hand side of the equation (A3) is defined by prescient information based on a prior probability model and is referred to as a normalization term in general. This prescient information is information with respect to the high-resolution image to be estimated. The term f(x) is set based on prior knowledge that a high-resolution image has little high frequency components, for instance. More specifically, for instance, f(x) is expressed by the equation (A4) below, using a matrix P formed by a high-pass filter such as a Laplacian filter and a parameter λ indicating strength of weight of the normalization term with respect to the evaluation function E[x].

f(X)=λ∥Px∥² (A4)

When the normalization term according to the equation (A4) is substituted into the equation (A3), the evaluation function E[x] is expressed as shown in the equation (A5) below. The equation (A5) includes unknown quantities corresponding to the pixel number of the high-resolution image. Therefore, for instance, if the image to be a target of the super-resolution process has a normal size like 1280×960 pixels, it is difficult to solve the equation because of the large pixel number. Therefore, a repeating computational such as the steepest descent method or the conjugate gradient method is used in general.

E[x]=∥y−Ax∥²+λPx∥² (A5)

In contrast, the pixel value x of the high-resolution image can be calculated directly from the equation (A5) by using the property that a derivative of the evaluation function E[x] becomes zero when the evaluation function E[x] is minimized. More specifically, when the derivative ∂E[x]/∂x of the high-resolution image with respect to the pixel value x becomes zero, i.e., when the equation (A6) below holds, the equation (A7) also holds. Therefore, the pixel value x of the high-resolution image can be calculated in accordance with the equation (A7). Here, the matrix with the superscript T indicates a transposed matrix of an original matrix. Therefore, for instance, A^{T} indicates a transposed matrix of the matrix A (the same is true on the matrix P and the like).

∂E[x]/∂x=−A^{T}(y−Ax)+λP^{T}Px=0 (A6)

x=(A^{T}A+λP^{T}P)⁻¹A^{T}y (A7)

When the pixel value y of the actual low-resolution image is multiplied by the (A^{T}A+λP^{T}P)⁻¹A^{T} of the equation (A7), the pixel value x of the high-resolution image can be obtained. Actually, a filter having filter factors as elements of the matrix expressed by (A^{T}A+λP^{T}P)⁻¹A^{T} is formed, and this filter is made to act on the pixel value y so that the pixel value x is obtained. However, the number of filter factors of this filter depends on the number of actual low-resolution images to be used for the super-resolution process and the pixel number thereof, and the pixel number of the high-resolution image.

Therefore, as described above, if the image to be a target of the super-resolution process has a normal size like 1280×960 pixels, the number of filter factors for calculating the pixel value of the high-resolution image becomes too large. As a result, a circuit scale of an arithmetic circuit constituting the filter for performing the super-resolution process becomes large. In addition, a quantity of the calculation also becomes a massive amount so that the calculation cannot be performed. In view of these circumstances, the conventional super-resolution process includes updating the high-resolution image repeatedly based on a gradient quantity obtained by using a gradient method or the like so as to obtain a final high-resolution image. However, it is necessary to increase the number of repeating the update process in order to obtain a high-resolution image with high reproducibility, resulting in a lot of time necessary for the calculation. In addition, since there is an upper limit of period of time for taking one frame of picture of a moving image or the like, there is also a limit of the number of repeating the above-mentioned process. As a result, it is difficult to obtain a high-resolution image with high reproducibility.

### SUMMARY OF THE INVENTION

An image processing apparatus according to an embodiment of the present invention includes a high resolution processing portion for generating a high-resolution image from a first low-resolution image to be a datum frame and M (M is an integer of one or larger) second low-resolution images, the high-resolution image having a higher resolution than the low-resolution images, and a region cutting out portion for setting a first target region in an image region of the first low-resolution image and for setting a second target region in an image region of the second low-resolution image. The high resolution processing portion calculates a pixel value of a region corresponding to the first target region in an image region of the high-resolution image based on pixel values of the first and the second target regions set by the region cutting out portion. The region cutting out portion scans a position of the first target region to be set in the first low-resolution image and sets the second target region at a position corresponding to the position of the first target region after the scan every time when the high resolution processing portion calculates the pixel value of the high-resolution image.

More specifically, for instance, if the integer M is one, the image processing apparatus may further include a motion amount calculation portion for calculating an amount of motion between the first low-resolution image and the second low-resolution image, and the region cutting out portion may set the position of the second target region based on the amount of motion.

More specifically, for instance, if the integer M is two or larger, the image processing apparatus may further include a motion amount calculation portion for calculating an amount of motion between the first low-resolution image and the second low-resolution image for each of the second low-resolution images, and the region cutting out portion may set the position of the second target region based on the amount of motion for each of the second low-resolution images.

In addition, for instance, the high resolution processing portion may be made up of a filter for calculating the pixel value of the high-resolution image from pixel values of the first and the second target regions, and a filter factor of the filter may be updated based on a positional relationship between the first and the second target regions set by the region cutting out portion every time when the position of the first target region is scanned.

In addition, for instance, the positional relationship may be classified into a plurality of types of positional relationships, the image processing apparatus may further include a filter factor storage portion for storing a filter factor of the filter for each of the types of the positional relationships, and a filter factor corresponding to the positional relationship between the first and the second target regions set by the region cutting out portion may be read out from the filter factor storage portion, so that the read-out filter factor is set as the filter factor of the filter constituting the high resolution processing portion.

Further, when the high resolution processing portion performs the high resolution processing on pixels in the first and the second target regions, one or more pixels positioned at the middle of the first target region may be handled as target pixels so that the pixel values of the pixels on the high-resolution image corresponding to the target pixels can be calculated. On this occasion, as the filter factor, only the filter factor of the line corresponding to the pixel obtained in the high-resolution image may be used for the calculation for performing the high resolution processing.

In addition, the filter may be made up of a matrix (A^{T}A+λP^{T}P)⁻¹A^{T} obtained by the equation (A7) in order to make the derivative of the evaluation function for the super-resolution process to be zero. In addition, a filter factor of the filter constituting the high resolution processing portion may be made up of a factor obtained when the calculation is performed two times by the super-resolution process of the reconstruction type.

An electronic appliance according to an embodiment of the present invention has the above-mentioned image processing apparatus and obtains (M+1) images as an external input or by exposure so that an image signal of the (M+1) images is supplied to the image processing apparatus. The (M+1) images include the first low-resolution image and the M second low-resolution images.

An image processing method according to an embodiment of the present invention includes a high resolution processing step for generating a high-resolution image from a first low-resolution image to be a datum frame and M (M is an integer of one or larger) second low-resolution images, the high-resolution image having a higher resolution than the low-resolution images, and a region cutting out step for setting a first target region in an image region of the first low-resolution image and for setting a second target region in an image region of the second low-resolution image. The high resolution processing step includes calculating a pixel value of a region corresponding to the first target region in an image region of the high-resolution image based on pixel values of the first and the second target regions set by the region cutting out step. The region cutting out step includes scanning a position of the first target region to be set in the first low-resolution image and setting the second target region at a position corresponding to the position of the first target region after the scan every time when the pixel value of the high-resolution image is calculated in the high resolution processing step.

### BRIEF DESCRIPTION OF THE DRAWINGS

FIG. 1 is a general block diagram of an image sensing apparatus according to an embodiment of the present invention.

FIGS. 2A to 2C are diagrams showing a positional relationship between two actual low-resolution images to be a target of a super-resolution process.

FIG. 3 is a diagram showing a relationship between a super-resolution target pixel and a super-resolution target region on the actual low-resolution image to be a target of the super-resolution process.

FIG. 4A is a diagram showing the super-resolution target pixel and the super-resolution target region on the actual low-resolution image as a datum frame.

FIG. 4B is a diagram showing a relationship between a super-resolution target region on the actual low-resolution image as the datum frame and a super-resolution target region on the actual low-resolution image as a consulted frame.

FIG. 5A is a diagram showing a manner in which the super-resolution target region is scanned on the actual low-resolution image as the datum frame.

FIGS. 5B and 5C are diagrams showing manners in which the super-resolution target region is scanned on the actual low-resolution image as a consulted frame in comparison with that on the datum frame.

FIG. 6 is a diagram showing a pixel position of a pixel on the high-resolution image corresponding to the super-resolution target pixel on the actual low-resolution image.

FIGS. 7A to 7D are diagrams for explaining a basic concept of the super-resolution process according to the embodiment of the present invention, in which FIG. 7A shows luminance distribution of a subject while FIGS. 7B to 7D show image data concerning the subject.

FIGS. 8A to 8D are diagrams for explaining a basic concept of the super-resolution process according to the embodiment of the present invention.

FIG. 8E is a flowchart showing a flow of the super-resolution process according to the embodiment of the present invention.

FIG. 9 is a diagram showing a region on the high-resolution image in which a pixel value can be obtained by performing the super-resolution process on the super-resolution target region in the actual low-resolution image.

FIG. 10 is a partial block diagram of the image sensing apparatus shown in FIG. 1, which includes an internal block diagram of an image processing portion shown in FIG. 1.

FIG. 11 is a diagram showing a manner in which a whole region of one image is divided into a plurality of detection regions, and a manner in which each of the detection regions is further divided into a plurality of small regions.

FIG. 12A is a diagram showing a manner in which one representative point is set in the small region shown in FIG. 11. FIG. 12B is a diagram showing a manner in which a plurality of sampling point are set in the small region shown in FIG. 11.

FIGS. 13A and 13B are diagrams for explaining a motion amount detection process by a sub pixel unit.

FIGS. 14A and 14B are diagrams for explaining a motion amount detection process by a sub pixel unit.

FIG. 15 is a diagram showing a pixel positional relationship between the datum frame and the consulted frame after alignment.

FIG. 16A is a diagram showing a filter as a point spread function for generating an estimated low-resolution image from the high-resolution image.

FIG. 16B is a diagram showing a noted pixel and the surrounding pixels in the high-resolution image.

FIG. 17A is a diagram showing a certain low-resolution image and another low-resolution image having a position error by one pixel of the high-resolution image in the horizontal direction with respect to the former low-resolution image.

FIG. 17B is a diagram showing the both images overlaid on a common coordinate system.

FIG. 18A is a diagram showing a certain low-resolution image and another low-resolution image having a position error by one pixel of the high-resolution image in the vertical direction with respect to the former low-resolution image.

FIG. 18B is a diagram showing the both images overlaid on a common coordinate system.

FIGS. 19A to 19C are diagrams showing the positional relationships between each pixel on the first to the third low-resolution images respectively and each pixel on the high-resolution image.

FIGS. 20A to 20C are diagrams showing the positional relationships between one pixel on the first to the third low-resolution images respectively and three pixels on the high-resolution image.

FIGS. 21A to 21C are diagrams showing rectangular regions of 3×3 pixels including a first to a third noted pixels respectively as the center pixel on the high-resolution image.

FIGS. 22A to 22B are diagrams showing rectangular regions of 5×5 pixels including the noted pixel as the center pixel on the high-resolution image.

FIG. 23 is a diagram showing a rectangular region of 9×9 pixels including the noted pixel as the center pixel on the high-resolution image.

FIG. 24 is a general block diagram of a display device according to an embodiment of the present invention.

FIG. 25 is a diagram showing three low-resolution images that are used for the conventional high resolution conversion.

FIG. 26 is a diagram for explaining an interpolation process utilizing the high resolution conversion based on the low-resolution image shown in FIG. 25 according to the conventional technique.

FIG. 27 is a diagram for explaining another high resolution conversion based on the low-resolution image shown in FIG. 25 according to the conventional technique.

FIG. 28 is a diagram for explaining still another high resolution conversion according to the conventional technique, in which the high-resolution image is obtained by using a weighted average process.

### DETAILED DESCRIPTION OF THE PREFERRED EMBODIMENTS

Hereinafter, an embodiment of the present invention will be described with reference to the attached drawings. In the drawings to be referred to, the same part is denoted by the same reference numeral or symbol so that overlapping description of the same part will be omitted as a rule. In the description below, an image sensing apparatus such as a digital camera or a digital video is exemplified mainly as an electronic appliance equipped with an image processing apparatus (corresponding to an image processing portion that will be described later) performing the image processing according to the present invention. However, as described later, it is possible to form a display device performing the digital image processing with a similar image processing apparatus (such as a liquid crystal display or a plasma television set). Note that the definitions of symbols (such as the symbol A representing the matrix in the equation (A2)) described in “BACKGROUND OF THE INVENTION” are also applied to the description of the embodiment.

[Structure of Image Sensing Apparatus]

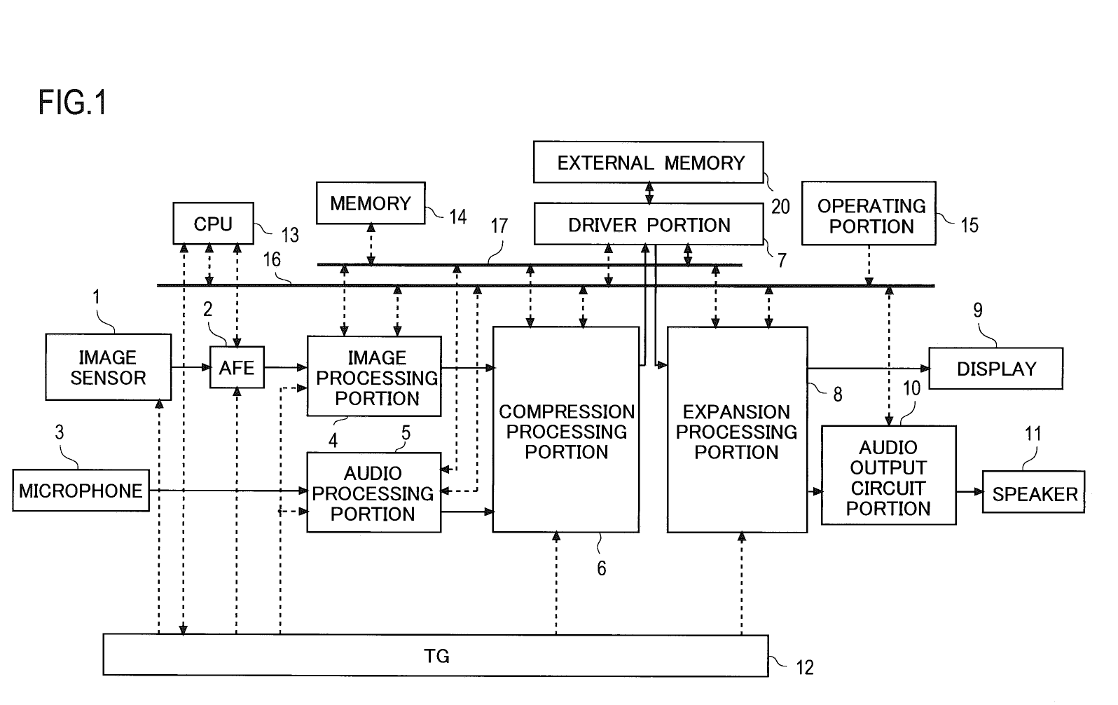

First, an internal structure of the image sensing apparatus according to the embodiment of the present invention will be described with reference to the drawings. FIG. 1 is a general block diagram showing the internal structure of the image sensing apparatus.

The image sensing apparatus shown in FIG. 1 includes an image sensor (solid-state image sensing device) 1 such as a CCD (Charge Coupled Device) or a CMOS (Complementary Metal Oxide Semiconductor) image sensor for converting incident light from a subject into an electric signal, an AFE (Analog Front End) 2 for converting an analog image signal received from the image sensor 1 into a digital image signal, a microphone 3 for converting sounds received from the outside into an electric signal, an image processing portion 4 for performing various image processing including the super-resolution process on the digital image signal from the AFE 2, an audio processing portion 5 for converting an analog audio signal from the microphone 3 into a digital audio signal, a compression processing portion 6 for performing a compression coding process on the image signal from the image processing portion 4 and the audio signal from the audio processing portion 5 in accordance with MPEG (Moving Picture Experts Group) compression method or the like, a driver portion 7 for recording a compression coded signal compressed and coded by the compression processing portion 6 (hereinafter also referred to as a compressed signal) in an external memory 20, an expansion processing portion 8 for expanding and decoding the compressed signal read out from the external memory 20 via the driver portion 7, a display portion 9 for displaying an image based on the image signal obtained by decoding in the expansion processing portion 8, an audio output circuit portion 10 for converting the audio signal from the expansion processing portion 8 into an analog audio signal, a speaker portion 11 for reproducing and outputting sounds based on the audio signal from the audio output circuit portion 10, a timing generator 12 for outputting a timing control signal for synchronizing operating timings of individual blocks in the image sensing apparatus, a CPU (Central Processing Unit) 13 for controlling general driving operation in the image sensing apparatus, a memory 14 for storing programs for the operations and for storing data temporarily when the programs are executed, an operating portion 15 for a user to input instructions, a bus line 16 for sending and receiving data between the CPU 13 and each of the individual blocks in the image sensing apparatus, and a bus line 17 for sending and receiving data between the memory 14 and each of the individual blocks in the image sensing apparatus.

When the operating portion 15 instructs to perform an exposure operation for taking a moving image in this image sensing apparatus, an analog image signal is obtained by a photoelectric conversion action of the image sensor 1 and is delivered to the AFE 2. On this occasion, the timing control signal is supplied from the timing generator 12 to the image sensor 1, so that horizontal scanning and vertical scanning are performed in the image sensor 1, so that data of individual pixels of the image sensor 1 are output as the image signal. In the AFE 2, the analog image signal is converted into the digital image signal. When the digital image signal is supplied to the image processing portion 4, various types of image processing is performed on the image signal. The image processing includes a signal conversion process for generating a luminance signal and a color difference signal.

When the operation for obtaining a high resolution image is performed with respect to the operating portion 15, the image processing portion 4 performs the super-resolution process based on the image signal of a plurality of frames supplied from the image sensor 1. The image processing portion 4 generates the luminance signal and the color difference signal based on the image signal obtained by performing the super-resolution process. Note that an amount of motion between different frames is calculated when the super-resolution process is performed, and alignment between frames is performed corresponding to the amount of motion (that will be described later in detail).

The image sensor 1 can expose successively at a predetermined frame period under control of the timing generator 12, so that an image sequence arranged in time series is obtained by the successive exposure. Each image constituting the image sequence is referred to as a frame image or a frame simply.

The image signal after the image processing (that may include the super-resolution process) performed by the image processing portion 4 is supplied to the compression processing portion 6. On this occasion, the analog audio signal obtained when the microphone 3 receives sounds is converted into the digital audio signal by the audio processing portion 5, which is supplied to the compression processing portion 6. The compression processing portion 6 compresses and codes the digital image signal and the audio signal from the image processing portion 4 and the audio processing portion 5 in accordance with the MPEG compression method, and it makes the external memory 20 store them via the driver portion 7. In addition, the compressed signal recorded in the external memory 20 is read out by the driver portion 7 and supplied to the expansion processing portion 8, which performs the expansion process so that the image signal based on the compressed signal is obtained. This image signal is supplied to the display portion 9, which displays the subject image obtained by the image sensor 1.

Although the operation when the moving image is obtained is described above, an operation when an exposure action for obtaining a still image is instructed with respect to the operating portion 15 is the same as that when the moving image is obtained. However, when obtaining a still image is instructed, the obtaining process of the audio signal by the microphone 3 is not performed, and the compressed signal including only the image signal is recorded in the external memory 20. In addition, not only the obtained still image is recorded but also the currently shot image is displayed. The compressed signal of the currently shot image is supplied to the display portion 9 via the expansion processing portion 8, so that the user can confirm the image obtained by the image sensor 1 at the present time. Note that it is possible to supply the image signal generated by the image processing portion 4 to the display portion 9 as it is without the compression coding process and the expansion process.

The image sensor 1, the AFE 2, the image processing portion 4, the audio processing portion 5, the compression processing portion 6 and the expansion processing portion 8 perform operations in accordance with the timing control signal from the timing generator 12 in synchronization with the exposure operation for each frame performed by the image sensor 1. Furthermore, when a still image is to be obtained, the timing generator 12 supplies the timing control signal to the image sensor 1, the AFE 2, the image processing portion 4 and the compression processing portion 6 so that their action timings are synchronized.

In addition, when reproduction of the moving image stored in the external memory 20 is instructed via the operating portion 15, the compressed signal corresponding to the moving image stored in the external memory 20 is read out by the driver portion 7 and is supplied to the expansion processing portion 8. Then, expansion processing portion 8 expands and decodes the read-out compressed signal based on the MPEG compression method, so that the image signal and the audio signal are obtained. The obtained image signal is supplied to the display portion 9 for displaying the image, and the obtained audio signal is supplied to the speaker portion 11 via the audio output circuit portion 10 for reproducing and outputting sounds. In this way, the moving image based on the compressed signal recorded in the external memory 20 is reproduced together with sounds. Furthermore, if the compressed signal includes only the image signal, the image is only reproduced and displayed on the display portion 9.

As described above, the image processing portion 4 is formed to be capable of performing the super-resolution process. The super-resolution process enables to generate one high-resolution image from a plurality of low-resolution images. The image signal of the high-resolution image can be recorded in the external memory 20 via the compression processing portion 6. The resolution of the high-resolution image is higher than that of the low-resolution image, and the pixel numbers in the horizontal direction and in the vertical direction of the high-resolution image are larger than those of the low-resolution image. For instance, when exposure of a still image is instructed, a plurality of frames (frame images) are obtain as the plurality of low-resolution images, and the super-resolution process is performed on them so that the high-resolution image is generated. Alternatively, for instance, when a moving image is shot, the super-resolution process is performed on a plurality of frames (frame images) as the obtained plurality of low-resolution images.

In the image sensing apparatus according to this embodiment, a plurality of low-resolution images obtained by using the image sensor 1 is used for estimating one high-resolution image. The low-resolution image obtained by using the image sensor 1 is referred to as the actual low-resolution image.

The high-resolution image is generate with reference to one of the plurality of actual low-resolution images. The actual low-resolution image to be the reference is referred to as a datum frame. Among the plurality of actual low-resolution images for generating the high-resolution image, one that is different from the datum frame is referred to as a consulted frame.

Furthermore, in the following description, abbreviations of the low-resolution image and the like may be used by adding reference symbols. For instance, in the following description, if “Fa” is assigned as a symbol indicating a certain actual low-resolution image, the actual low-resolution image Fa may be referred to as an “image Fa” simply, which represents the same matter.

[Basic Action of the Super-Resolution Process]

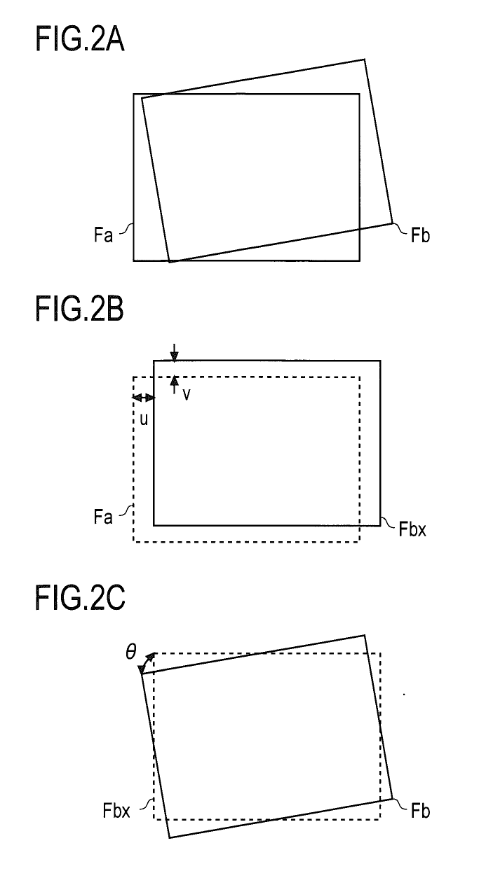

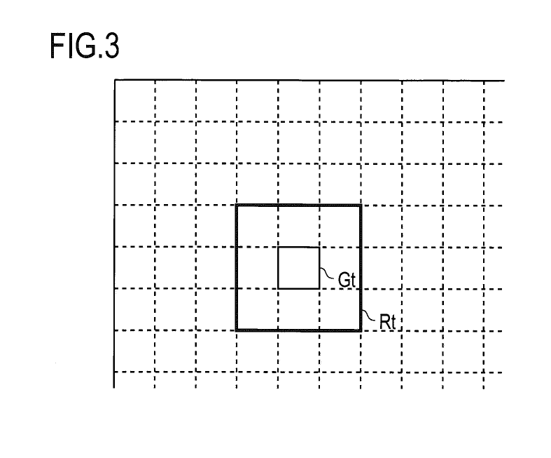

A basic action of the super-resolution process performed by the image processing portion 4 shown in FIG. 1 will be described with reference to the drawings. FIGS. 2A to 2C, 3, 4A, 4B, and 5A to 5C are diagrams for explaining individual actions of the super-resolution process performed by the image processing portion 4. FIGS. 2A to 2C are diagrams showing positional relationships between two actual low-resolution images to be a target of the super-resolution process. FIGS. 3, 4A, 4B, and 5A to 5C are diagrams showing set situations of the region in which the super-resolution process is performed.

When the image processing portion 4 performs the super-resolution process, an amount of motion between the actual low-resolution image as a consulted frame and the actual low-resolution image as the datum frame is calculated first. If a plurality of consulted frames exist, the amount of motion between each of the consulted frames and the datum frame is calculated. The amount of motion between the two images indicates a quantity of a position error (displacement) between the two images. The amount of motion is a two-dimensional quantity and is also called a motion vector or a displacement vector in general. The amount of motion includes an amount of motion in a translational direction and an amount of motion in a rotational direction. In other words, the amount of motion is divided into a translational component and a rotational component. The amount of motion in the translational direction can be further divided into a horizontal component and a vertical component. The image processing portion 4 is formed to be capable of calculating the amounts of motion in the translational and the rotational directions. In the image processing portion 4, the alignment between the datum frame and the consulted frame is performed based on the amount of motion between actual low-resolution images that are used for the super-resolution process. The alignment is realized by translational and/or rotational motion of one of the two images such that the position error corresponding to the amount of motion can be cancelled. Note that the term “alignment” has the same meaning as “position error correction” that will be described later.

For instance, if the amount of motion between two actual low-resolution images Fa and Fb includes the translational component and the rotational component, a positional relationship between the actual low-resolution images Fa and Fb after the alignment is the positional relationship as shown in FIG. 2A. However, it is supposed that magnitudes of the horizontal and the vertical components of the amount of motion in the translational direction between the actual low-resolution images Fa and Fb have values corresponding respectively to u and v pixels of the actual low-resolution image, and that the amount of motion in the rotational direction between the actual low-resolution images Fa and Fb is expressed by an angle θ. In other words, as shown in FIG. 2B, the actual low-resolution image Fb is moved by a distance corresponding to the u pixel in the horizontal direction and by a distance corresponding to the v pixel in the vertical direction in a translational manner with respect to the actual low-resolution image Fa on the image coordinate system in which arbitrary images including the actual low-resolution image and the high-resolution image are commonly defined, so as to obtain an image Fbx. Then, as shown in FIG. 2C, the image Fbx is further moved in a rotational manner around the center of the image Fbx by the angle θ. Thus, the actual low-resolution image Fb after the alignment is obtained as shown in FIG. 2A or 2C.

After the alignment is performed between the plurality of actual low-resolution images to be a target of the super-resolution process, a region in which the super-resolution process is performed (hereinafter referred to as a super-resolution target region) is set with respect to each of the actual low-resolution images after the alignment. On this occasion, pixel to be a target of the super-resolution (hereinafter referred to as a super-resolution target pixel) is selected from pixels forming the actual low-resolution image as the datum frame, and the super-resolution target region including the super-resolution target pixel and a plurality of pixels surrounding the super-resolution target pixel is set with respect to the actual low-resolution image as the datum frame.

The super-resolution target pixel is made up of one or more plurality of pixels. It is supposed that the super-resolution target pixel is made up of Tx×Ty pixels. When the super-resolution process on a certain super-resolution target pixel is completed, the position of the super-resolution target pixel is shifted by Tx pixels in the horizontal direction, and the super-resolution target region is set again for the super-resolution target pixel after shifting the position (Tx and Ty are natural numbers). Such scanning of the position of the super-resolution target pixel in the horizontal direction is performed sequentially, so that the super-resolution process is performed for one line of pixels set as the super-resolution target pixel. Then, the line of pixels is shifted in the vertical direction by Ty pixels so that pixels on the line are selected as the super-resolution target pixel for setting the super-resolution target region corresponding to the selected contents. This scan of changing the position of the super-resolution target pixel and the super-resolution target region sequentially is referred to as a “raster scan”.

More specifically, in the raster scan, the positions of the super-resolution target pixel and the super-resolution target region are shifted in the horizontal direction in turn while selection of the super-resolution target pixel and the super-resolution target region is performed for one line. After that, the pixel and the region to be selected as the super-resolution target pixel and the super-resolution target region are shifted in the vertical direction by Ty pixels, and the positions of the super-resolution target pixel and the super-resolution target region are shifted in the horizontal direction in turn while selection of the super-resolution target pixel and the super-resolution target region is performed again. “Tx×Ty pixels” means a group of total (Tx×Yy) pixels in which Tx pixels are arranged in the horizontal direction and Ty pixels are arranged in the vertical direction. Expressions “1×1 pixel” and “3×3 pixels” that will be described later are also interpreted in the same manner.

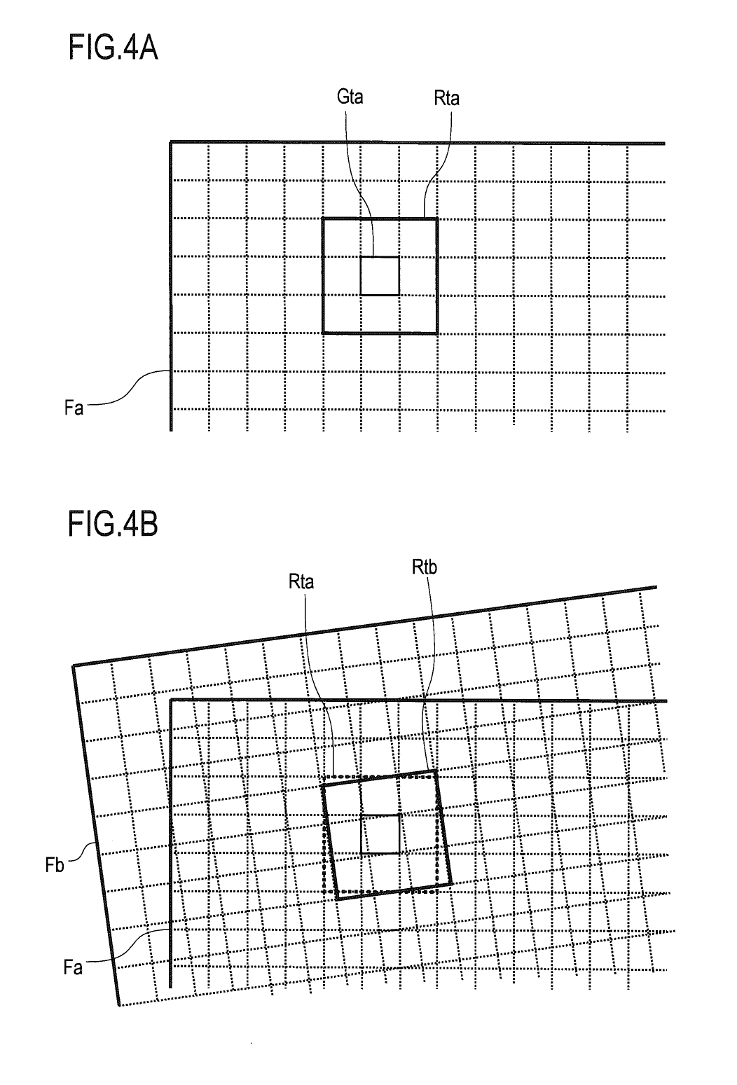

For instance, as shown in FIG. 3, it is supposed that 1×1 pixel is set as the super-resolution target pixel Gt and that the region including the 3×3 pixels with the super-resolution target pixel Gt as its center pixel is set as the super-resolution target region Rt. In this case, the raster scan is performed in which the position of the super-resolution target pixel is scanned by one pixel each in the horizontal direction and in the vertical direction in the image region of the datum frame, so that the super-resolution target region Rt is set one after another in the image region of the datum frame. Then, the super-resolution target region including 3×3 pixels is set also in each of the image regions of the consulted frame with reference to the positions of super-resolution target pixel Gt and the super-resolution target region Rt set with respect to the datum frame. However, it is supposed that the super-resolution target region with respect to the consulted frame is set with respect to the consulted frame after the above-mentioned alignment. In addition, the super-resolution target region in the consulted frame is set so that the magnitude of the amount of motion (position error amount) between the super-resolution target region set with respect to the datum frame and the super-resolution target region set with respect to the consulted frame becomes smaller than a size of one pixel on the actual low-resolution image. Note that broken lines in FIG. 3 as well as in FIGS. 4A and 4B indicate boundary lines between neighboring pixels.

The actual low-resolution images Fa and Fb after the alignment in the positional relationship as shown in FIG. 2A are exemplified for describing the method for setting the super-resolution target region more in detail as below. It is supposed that the actual low-resolution image Fa is the datum frame and that the actual low-resolution image Fb is the consulted frame. As described above, the position of the super-resolution target pixel is changed sequentially by the raster scan in the image Fa. As shown in FIG. 4A, the super-resolution target pixel in the image Fa is denoted by Gta, and the super-resolution target region in the image Fa set corresponding to the super-resolution target pixel Gta is denoted by Rta.

FIG. 4B shows the images Fa and Fb after the above-mentioned alignment in an overlaying manner. In FIG. 4B, the rectangular region of the solid line denoted by reference symbol Rtb is the super-resolution target region set in the image Fb corresponding to the super-resolution target region Rta. The position of the super-resolution target region Rtb is set with reference to the position of the super-resolution target region Rta on the image coordinate system, so that the super-resolution target region Rta and the super-resolution target region Rtb have overlapping area as large as possible, based on the amount of motion obtained when the images Fa and Fb are aligned. Therefore, the magnitude of the amount of motion (position error amount) between the region Rta and the region Rtb is smaller than a size of one pixel on the actual low-resolution image.

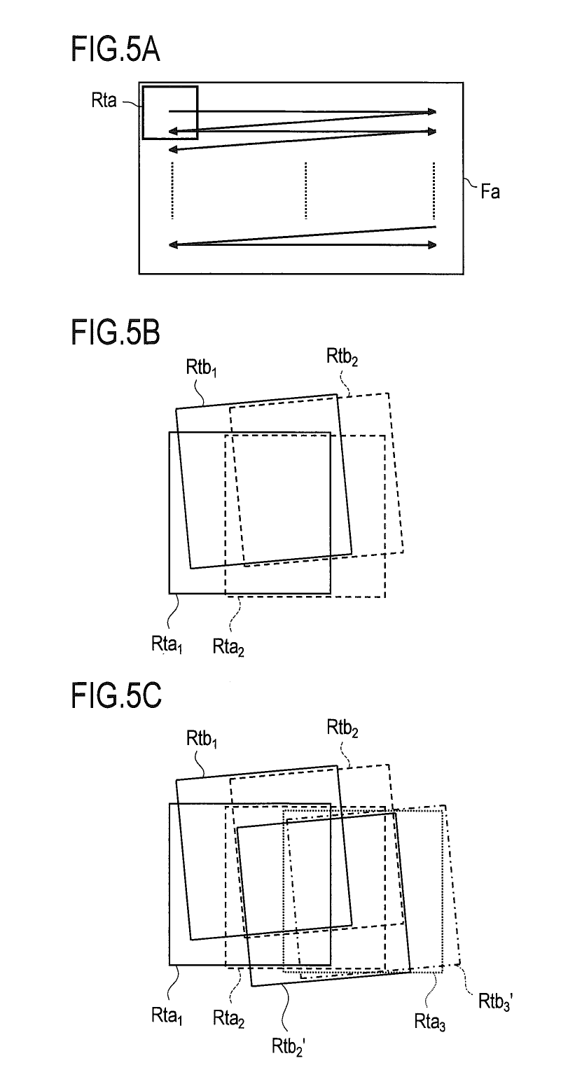

As shown in FIG. 5A, the raster scan of the super-resolution target pixel Gta is performed in the image Fa, so that the position of the super-resolution target region Rta is scanned for one line in the horizontal direction and then is scanned in the vertical direction in the image Fa. The arrows in FIG. 5A indicate the direction of the scan. Then, every time when the position of the region Rta is changed, the super-resolution target region Rtb is set in the image Fb so that the region Rta and the region Rtb are overlapped with each other as described above.

In other words, along with the scan of the region Rta in the image Fa, the region Rtb is also scanned in the image Fb. However, since the images Fa and Fb have the positional relationship as shown in FIG. 2A, the scan of the region Rtb in the image Fb is not completely equal to the scan of the region Rta in the image Fa. The scan of the region Rtb becomes the scan of the region Rta plus the amount of motion between the images Fa and Fb. When the region Rta is scanned in the horizontal direction in the image Fa, the region Rtb moves in the horizontal direction, and it may also move in the vertical direction depending on the amount of motion between the images Fa and Fb.

This situation of the scan of the region Rtb will be described with reference to FIGS. 5B and 5C. In FIGS. 5B and 5C, the rectangular region Rta₁ of the solid line indicates the super-resolution target region Rta that is set in the image Fa at a certain noted timing, and the rectangular region Rtb₁ of the solid line indicates the super-resolution target region Rtb that is set in the image Fb at the noted timing (i.e., the super-resolution target region Rtb set corresponding to the super-resolution target region Rta₁).

The rectangular region Rta₂ of the broken line indicates the super-resolution target region Rta that is set next to the region Rta₁ by the raster scan in the horizontal direction, and the rectangular region Rta₃ of the broken line indicates the super-resolution target region Rta that is set next to the region Rta₂ by the raster scan in the horizontal direction. The positions (center positions) of the regions Rta₂ and Rta₃ are shifted with respect to the position (center position) of the region Rta₁ in the horizontal direction by one pixel and by two pixels, respectively.

The rectangular region Rtb₂ of the broken line is a region including 3×3 pixels shifted from the region Rtb₁ by one pixel in the horizontal direction of the image Fb. The rectangular region Rtb₂′ of the solid line is a region including 3×3 pixels shifted from the region Rtb₂ by one pixel in the vertical direction of the image Fb. The rectangular region Rtb₃′ of the dashed dotted line is a region including 3×3 pixels shifted from the region Rtb₂′ by one pixel in the horizontal direction of the image Fb. Note that the individual regions are shown at positions shifted upward, downward, rightward or leftward a little from their original positions so that different regions can be distinguished from each other in FIGS. 5B and 5C.

It is supposed that an influence of the rotational component of the amount of motion between the images Fa and Fb can be ignored. Then, if the super-resolution target region Rta in the image Fa is the region Rta₂, the super-resolution target region Rtb in the image Fb is to be the region Rtb₂. However, the amount of motion includes the rotational component in this example. Therefore, if the region Rtb is scanned only in the horizontal direction while the region Rta is scanned in the horizontal direction, the amount of motion (position error amount) between the regions Rta and Rtb will increase every time when the regions Rta and Rtb are scanned.

In order to satisfy the requirement that the overlapping area between the regions Rta and Rtb should be as large as possible, the image processing portion 4 compares a size of the overlapping area between the regions Rta₂ and Rtb₂ with a size of the overlapping area between the regions Rta₂ and Rtb₂′ when the super-resolution target region Rtb corresponding to the region Rta₂ is set in the image Fb. Then, if the former is larger than latter, the image processing portion 4 sets the region Rtb₂ as the super-resolution target region Rtb corresponding to the region Rta₂ in the image Fb. On the contrary, if the latter is larger than the former, the image processing portion 4 sets the region Rtb₂′ as the super-resolution target region Rtb corresponding to the region Rta₂ in the image Fb. If the region Rtb₂′ is set as the super-resolution target region Rtb, the super-resolution target region Rtb to be set in the image Fb corresponding to the super-resolution target region Rta₃ becomes the region Rtb₃′.

In this way, the super-resolution target region is set with respect to the actual low-resolution image as the datum frame by the raster scan corresponding to the pixel number of the super-resolution target pixels. In contrast, the super-resolution target region with respect to the actual low-resolution image as a consulted frame is set based on the amount of motion between itself and the datum frame so that a size of the overlapping area between the super-resolution target regions set with respect to the datum frame and the consulted frame is as large as possible.

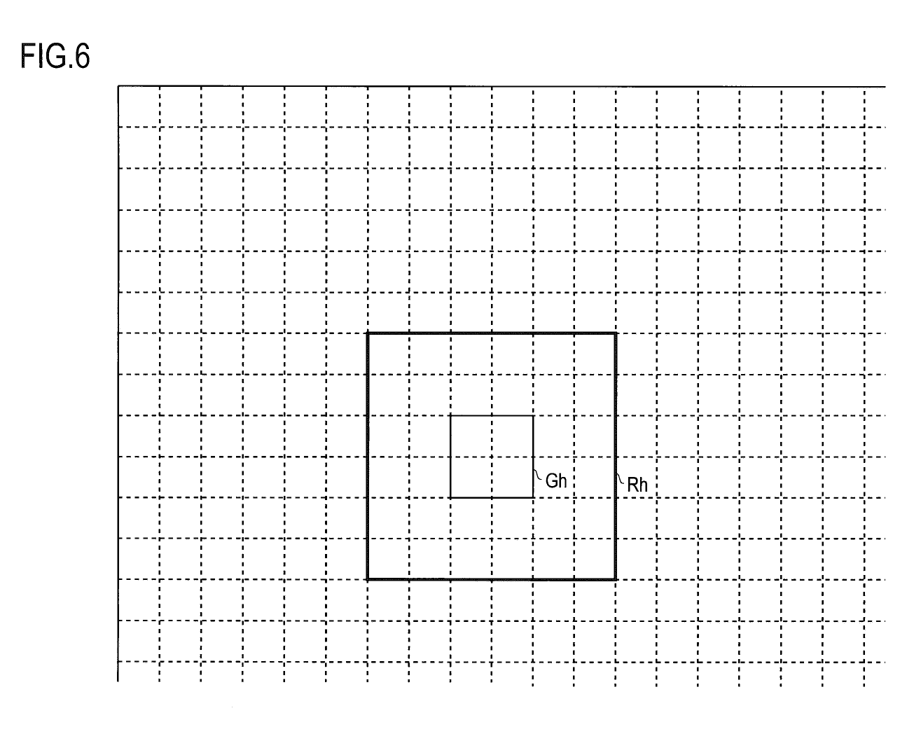

When the super-resolution target region is set with respect to each of the plurality of actual low-resolution images to be used for the super-resolution process, calculation based on pixel values of pixels in the set super-resolution target region is performed, so that the pixel value at the pixel position on the high-resolution image corresponding to the position of the super-resolution target pixel in the datum frame is calculated. For instance, as shown in FIG. 3, it is supposed that the super-resolution target region Rt is a 3×3 pixel region and that one pixel positioned at the center of the region is set as the super-resolution target pixel Gt. In this case, if an enlargement ratio of the resolution of the high-resolution image with respect to the low-resolution image is two times in the vertical and in the horizontal directions, pixel values are obtained with respect to four pixels in the 2×2 pixel region Gh positioned in the middle of the 6×6 pixel region Rh of the high-resolution image as shown in FIG. 6. Note that, the horizontal direction corresponds to the left and right direction while the vertical direction corresponds to the up and down direction in an image.

The position of the region Gh on the high-resolution image to be generated is defined with respect to the position of the super-resolution target pixel Gt on the actual low-resolution image as the datum frame. For instance, the center position of the region Gh is made to be identical to the center position of the pixel Gt on the image coordinate system in which arbitrary images including the actual low-resolution image and the high-resolution image are commonly defined. Therefore, every time when the super-resolution target region is moved by the raster scan on the datum frame, the position of the region Gh also moves on the high-resolution image, so that the pixel values on the high-resolution image with respect to the individual pixel positions are calculated sequentially.

If the enlargement ratio of the resolution of the high-resolution image with respect to the low-resolution image in the vertical direction and in the horizontal direction are V and H times respectively, the pixel values on the high-resolution image are calculated for pixels of (V×H) times the number of super-resolution target pixels set in the datum frame. For instance, if V=3 and H=4, the pixel numbers in the vertical and in the horizontal directions of the high-resolution image are respectively three times and four times the pixel numbers in the vertical and in the horizontal directions of the actual low-resolution image. Further, if the number of the super-resolution target pixel set in the datum frame is one, (V×H), i.e., (3×4) pixel values of high-resolution image are calculated with respect to one super-resolution target pixel. Then, all the pixels constituting the actual low-resolution image as the datum frame are set as the super-resolution target pixel one by one, so that the pixel values of all pixels of the high-resolution image to be generated can be obtained.

[Basic Concept of Super-Resolution Process]

Next, basic concept of the super-resolution process according to the embodiment will be described. As described above in “BACKGROUND OF THE INVENTION”, the relational expression “y=Ax+NOIZE” of the above equation (A2) holds between the vector x in which all the pixel values of the estimated high-resolution image are made to be a vector and the vector y in which all the pixel values of the plurality of actual low-resolution images to be used for estimating the high-resolution image. Then, the evaluation function E[x] as expressed by the above equation (A5) is defined based on the equation (A2), and the pixel value x of the high-resolution image can also be determined so that the evaluation function E[x] is minimized. Actually, for instance, the pixel value x such that the derivative ∂E[x]/∂x becomes zero is determined so that the high-resolution image can be estimated.

In this way, the super-resolution process can be performed by performing the calculation so that the derivative ∂E[x]/∂x of the evaluation function E[x] becomes zero. In the super-resolution process using the repeating computational algorithm, the original low-resolution images (i.e., actual low-resolution images) are estimated from the high-resolution image that is once estimated. Then, the derivative ∂E[x]/∂x is determined based on a difference between the low-resolution images obtained by the estimation and the actual low-resolution images, and the high-resolution image is reconstructed so that a value of the derivative ∂E[x]/∂x becomes close to zero. The low-resolution images obtained by estimating the original low-resolution images from the high-resolution image that is once estimated are each also called an estimated low-resolution image in particular. Note that the super-resolution process of the reconstruction type can also be realized by using the repeating computational algorithm. Therefore, it is also possible to adopt a reconstruction type super-resolution process using the repeating computational algorithm as the super-resolution process using the repeating computational algorithm.

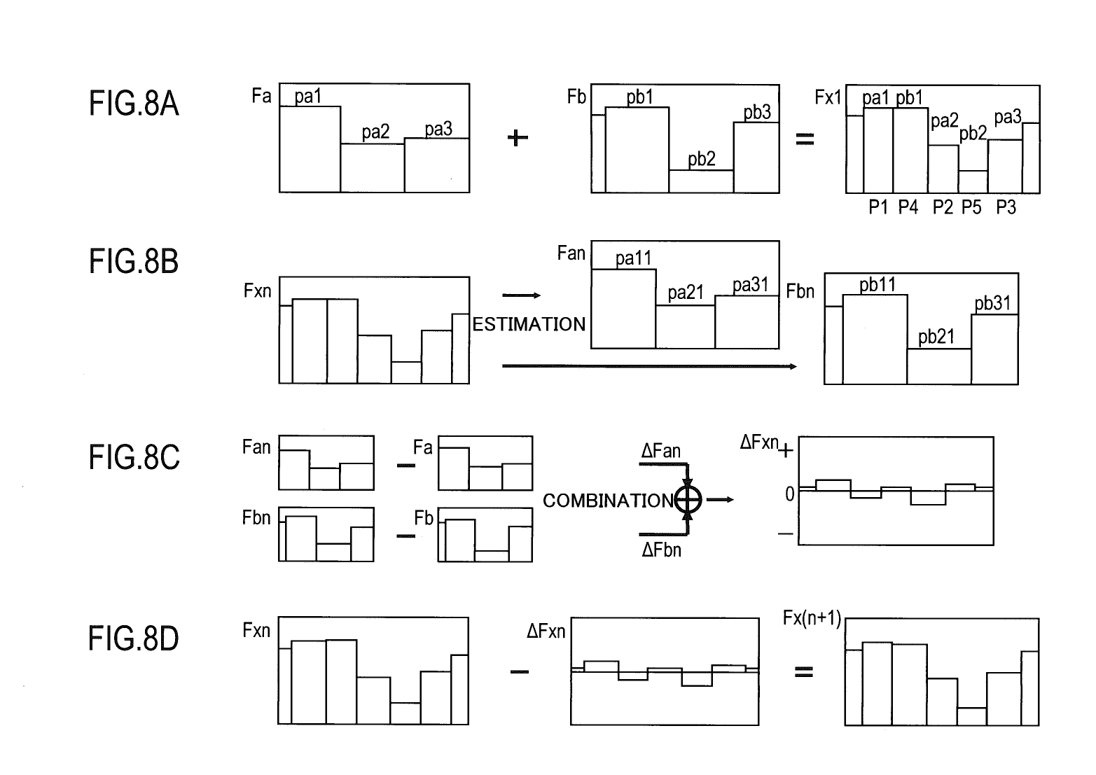

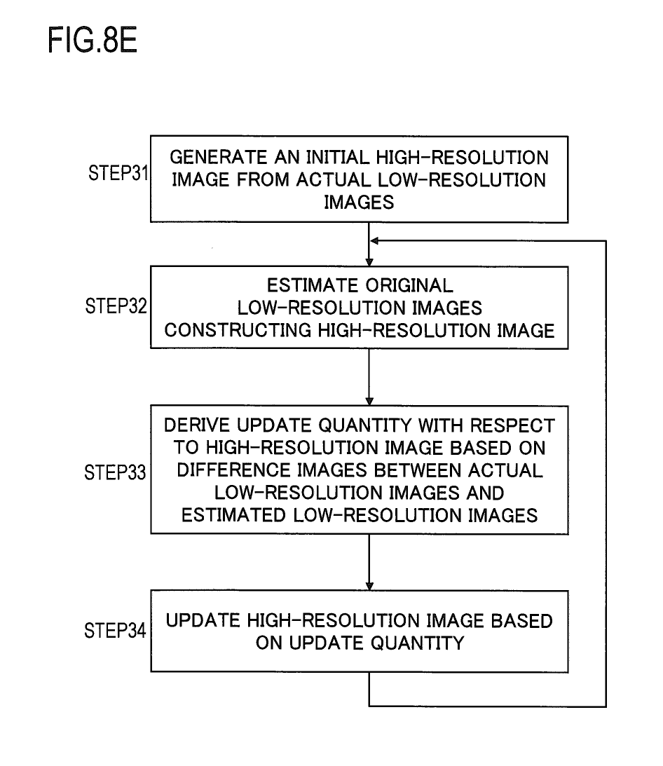

FIG. 8E is a flowchart showing a flow of the super-resolution process using the repeating computational algorithm. First, in the STEP 31, an initial high-resolution image is generated from the actual low-resolution images. In the next STEP 32, the original low-resolution images constructing the current high-resolution image are estimated. The estimated images are each referred to as the estimated low-resolution image as described above. In the next STEP 33, an update quantity with respect to the current high-resolution image is derived based on the difference images between the actual low-resolution images and the estimated low-resolution images. This update quantity is derived by performing the processes from the STEP 32 to the STEP 34 repeatedly so that an error between the actual low-resolution images and the estimated low-resolution images becomes minimized. Then, in the next STEP 34, the current high-resolution image is updated by using the update quantity so that a new high-resolution image is generated. After that, the process goes back to the STEP 32, and the processes from the STEP 32 to the STEP 34 are performed repeatedly regarding the newly generated high-resolution image as the current high-resolution image. Basically, as the number of repeating times of the processes from the STEP 32 to the STEP 34 increases, resolution of the obtained high-resolution image is improved substantially so that the high-resolution image close to an ideal state can be obtained.

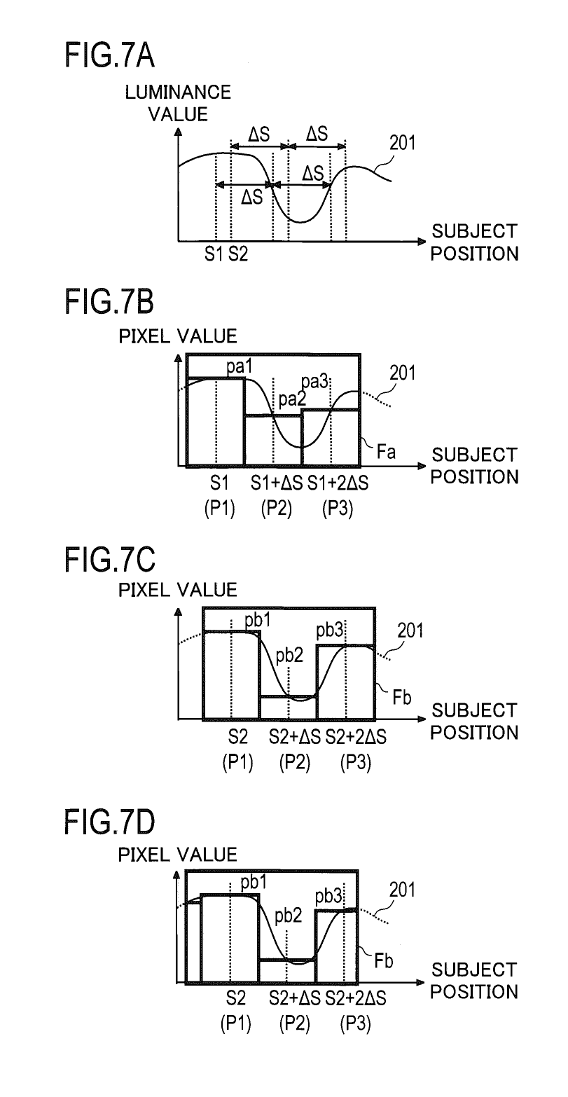

A general outline of the super-resolution process using the repeating computational algorithm will be described in more detail in relationship with the process from the STEP 31 to the STEP 34 with reference to FIGS. 7A to 7D and 8A to 8D. In this description of the general outline of the super-resolution process, it is supposed that each image is a one-dimensional image and that the super-resolution process is performed based on the two actual low-resolution images Fa and Fb for a simple description. In addition, concerning a certain noted pixel, the pixel value means information indicating luminance and color of the noted pixel, but it is supposed that the pixel value in the following description is a luminance value indicating luminance as long as there is no particular reference. In addition, in the following description, data indicating a pixel value of a certain image may be referred to as “image data”.

In each of FIGS. 7A to 7D, the curve 201 indicates a luminance distribution of a subject of the image sensing apparatus. In each of FIGS. 7A to 7D, the horizontal axis indicates a subject position, and the vertical axis indicates a pixel value (luminance value). FIG. 7B is an image diagram showing image data of the actual low-resolution image Fa obtained by exposing the subject at the time point T1, and FIG. 7C is an image diagram showing image data of the actual low-resolution image Fb obtained by exposing the subject at the time point T2. FIG. 7D will be described later. FIGS. 8A to 8D are diagrams showing a flow of the operation for obtaining the high-resolution image from the actual low-resolution image. FIGS. 8A, 8B, 8C and 8D correspond to the processes of the STEP 31, the STEP 32, the STEP 33 and the STEP 34 in FIG. 8E, respectively.

It is supposed that at the time point T1 luminance of the subject is sampled at the sampling points S1, (S+ΔS) and (S1+2ΔS) (see FIG. 7B). Here, ΔS indicates an adjacent pixel interval in the low-resolution image. On the other hand, each of the actual low-resolution images Fa and Fb is formed so as to have pixels P1 to P3. Therefore, the pixel values pa1, pa2 and pa3 of the pixels P1, P2 and P3 in the actual low-resolution image Fa are luminance values of the subject at the sampling points S1, (S1+ΔS) and (S1+2ΔS), respectively. On the other hand, it is supposed that at the time point T2 luminance of the subject is sampled at the sampling points S2, (S2+ΔS) and (S2+2ΔS) (see FIG. 7C). Therefore, the pixel values pb1, pb2 and pb3 of the pixels P1, P2 and P3 in the actual low-resolution image Fb are luminance values of the subject at the sampling points S2, (S2+ΔS) and (S2+2ΔS), respectively.

It is supposed that the time point T1 and the time point T2 are different from each other and that there is a deviation between positions at the sampling points S1 and S2 due to hand vibration or the like. Therefore, the actual low-resolution image Fb shown in FIG. 7C can be regarded as an image with a position error (displacement) corresponding to the amount of motion (S1−S2) with respect to the actual low-resolution image Fa shown in FIG. 7B. When the position error correction is performed with respect to the actual low-resolution image Fb shown in FIG. 7C so that the amount of motion (S1−S2) is canceled, the actual low-resolution image Fb is expressed as shown in FIG. 7D.

The actual low-resolution images Fa and Fb shown in FIGS. 7B and 7D after the position error correction are combined so that the high-resolution image Fx1 is estimated. The situation of the estimation is shown in FIG. 8A. In addition, the process of performing this estimation corresponds to the process of the STEP 31 in FIG. 8E. For a simple description, it is supposed that the resolution is doubled by the super-resolution process. In other words, it is supposed that the pixel P4 positioned at the middle between the pixels P1 and P2 as well as a pixel P5 positioned at the middle between the pixels P2 and P3 is set adding to the pixels P1 to P3, as a pixel of the high-resolution image Fx1.

It is supposed that the actual low-resolution image Fa is the datum frame (In this case, actual low-resolution image Fb is the consulted frame). Then, the pixel values of the pixels P1, P2 and P3 in the high-resolution image Fx1 are pixel values pa1, pa2 and pa3 in the actual low-resolution image Fa. The pixel value of the pixel P4 is, for instance, a pixel value of a pixel closest to the pixel position of the pixel P4 among the pixels (P1, P2 and P3) in the actual low-resolution images Fa and Fb after the position error correction. The pixel position of a certain noted pixel indicates the center position of the noted pixel. It is supposed that the pixel position of the pixel P1 in the actual low-resolution image Fb after the position error correction is closest to the pixel position of the pixel P4. Then, the pixel value of the pixel P4 is to be pb1. The pixel value of the pixel P5 is determined in the same manner, and it is supposed that the pixel value of the pixel P5 is to be pb2. In this way, the high-resolution image in which the pixel values of the pixels P1 to P5 are set to be pa1, pa2, pa3, pb1 and pb2 respectively can be estimated as the high-resolution image Fx1.

After that, a conversion equation having parameters of a down sampling quantity, a blur quantity due to a low resolution process and a position error amount (corresponding to the amount of motion) is exerted on the high-resolution image Fx1, so that estimated low-resolution images Fa1 and Fb1 as estimated images of the actual low-resolution images Fa and Fb are generated as shown in FIG. 8B. As apparent from the description later, the process including the estimation of the actual low-resolution images and the estimation of the high-resolution image based on the estimated actual low-resolution images are performed repeatedly. The estimated images of the actual low-resolution images Fa and Fb obtained by the n-th process are denoted by Fan and Fbn, respectively. In addition, the high-resolution image obtained by the n-th process is denoted by Fxn (n is a natural number). FIG. 8B illustrates the estimated low-resolution images obtained by the n-th process, i.e., the estimated low-resolution images Fan and Fbn generated based on the high-resolution image Fxn. The process of generating the estimated low-resolution images Fan and Fbn based on the high-resolution image Fxn corresponds to the process of the STEP 32 in FIG. 8E.

In the first STEP 32, the pixel values at the sampling points S1, (S1+ΔS) and (S1+2ΔS) are estimated based on the high-resolution image Fx1, and the estimated low-resolution image Fa1 having the estimated pixel values pall, pa21 and pa31 as the pixel values of the pixels P1, P2 and P3 is generated. Similarly, the pixel values at the sampling points S2, (S2+ΔS) and (S2+2ΔS) are estimated based on the high-resolution image Fx1, and the estimated low-resolution image Fb1 having the estimated pixel values pb11, pb21 and pb31 as the pixel values of the pixels P1, P2 and P3 is generated.

Then, as shown in FIG. 8C, a difference between the estimated low-resolution image Fa1 and the actual low-resolution image Fa, as well as a difference between the estimated low-resolution image Fb1 and the actual low-resolution image Fb is determined, so that the differences are combined for generating a difference image ΔFx1 with respect to the high-resolution image Fx1. The difference image with respect to the high-resolution image Fxn is denoted by ΔFxn (n is a natural number). FIG. 8C illustrates the difference image ΔFxn obtained by combining the difference images ΔFan and ΔFbn derived from the estimated low-resolution images Fan and Fbn and the actual low-resolution images Fa and Fb. The high-resolution image Fxn is updated by using the difference image ΔFxn so as to estimate an ideal high-resolution image (which will be described later in detail), and the difference image ΔFxn indicates contents of the update (update quantity). The process of calculating the difference image ΔFxn for deriving the contents of the update (update quantity) corresponds to the process of the STEP 33 in FIG. 8E.

The difference values (pa11−pa1), (pa21−pa2) and (pa31−pa3) of the pixel values of the pixels P1, P2 and P3 between the estimated low-resolution image Fa1 and the actual low-resolution image Fa are pixel values of the difference image ΔFa1. In addition, the difference values (pb11−pb1), (pb21−pb2) and (pb31−pb3) of the pixel values of the pixels P1, P2 and P3 between the estimated low-resolution image Fb1 and the actual low-resolution image Fb are pixel values of the difference image ΔFb1.

Then, the pixel values of the difference images ΔFa1 and ΔFb1 are combined, and difference values of the pixels P1 to P5 are calculated, so that the difference image ΔFx1 with respect to the high-resolution image Fx1 is generated. When the pixel values of the difference images ΔFa1 and ΔFb1 are combined so as to generate the difference image ΔFx1, the square error is used as the evaluation function in the MAP (Maximum A Posterior) method and the ML (Maximum-Likelihood) method (However, a normalization term is added to the evaluation function in the MAP method). More specifically, the value of the evaluation function in the MAP method or the ML method becomes a sum of square values of the pixel values of the difference images ΔFa1 and ΔFb1 between frames. Therefore, the gradient as the derivative of the evaluation function corresponds to a value proportional to two times the pixel values of the difference images ΔFa1 and ΔFb1. Therefore, the difference image ΔFx1 with respect to the high-resolution image Fx1 is calculated by using the value proportional to two times the pixel values of the difference images ΔFa1 and ΔFb1.

After the difference image ΔFx1 is generated, as shown in FIG. 8D, the pixel values (difference values) of the pixels P1 to P5 in the difference image ΔFx1 are subtracted from the pixel values of the pixels P1 to P5 in the high-resolution image Fx1 (in other words, the high-resolution image Fx1 is updated by using the difference image ΔFx1). According to this subtraction, the high-resolution image Fx2 is reconstructed. Compared with the high-resolution image Fx1, the high-resolution image Fx2 has a pixel value closer to the luminance distribution of the subject shown in FIG. 7A. Note that FIG. 8D illustrates the high-resolution image Fx(n+1) obtained by the n-th process, i.e., the high-resolution image Fx(n+1) obtained by subtracting the difference image ΔFxn from the high-resolution image Fxn. The process of obtaining the new high-resolution image Fx(n+1) by updating the high-resolution image Fxn based on the difference image ΔFxn as the update quantity corresponds to the process of the STEP 34 in FIG. 8E.

When the process from the STEP 32 to the STEP 34 is performed repeatedly, the pixel value of the difference image ΔFxn obtained in the STEP 33 decreases so that the pixel value of the high-resolution image Fxn converges to the pixel value matching substantially to the luminance distribution of the subject shown in FIG. 7A. Note that in the process of the n-th STEP 32 and STEP 34, the estimated low-resolution images Fan and Fbn and the high-resolution image Fx(n+1) are generated by using the high-resolution image Fxn obtained by the process of the previous (i.e., (n−1)th) STEP 34. Then, if the pixel value of the difference image ΔFxn becomes smaller than a predetermined value or the pixel value of the difference image ΔFxn converges, the high-resolution image Fxn obtained by the process of the previous STEP 34 (i.e., the process of (n−1)th STEP 34) is handled as the high-resolution image to be obtained finally. Then, the super-resolution process is finished.

When the reconstruction type super-resolution process is performed utilizing the repeating calculation described above, the above-mentioned process from the STEP 31 to the STEP 34 is performed for each of the super-resolution target regions set in the actual low-resolution image. In this case, the process from the STEP 32 to the STEP 34 is performed repeatedly for each of the super-resolution target regions set in the actual low-resolution image, so that pixel value of the pixel in the high-resolution image corresponding to the super-resolution target pixel is obtained. Then, every pixel of the actual low-resolution image as the datum frame is handled sequentially as the super-resolution target pixel so that the process from the STEP 31 to the STEP 34 is performed with respect to every pixel of the actual low-resolution image as the datum frame. Thus, pixel values of all the pixels in the high-resolution image can be obtained.

On the other hand, the pixel value x of the high-resolution image can be obtained also by multiplying the pixel value y of the actual low-resolution image by the (A^{T}A+λP^{T}P)⁻¹A^{T} in the above equation (A7) as described above in “BACKGROUND OF THE INVENTION”, so that the super-resolution process can be realized. More specifically, an FIR (Finite Impulse Response) filter having elements of the matrix expressed by the (A^{T}A+λP^{T}P)⁻¹A^{T} as its filter factors is formed, and the pixel value of the super-resolution target pixel in the low-resolution image is supplied to the FIR filter, so that the pixel value of the high-resolution image can be obtained.

The basic action of the process of obtaining the pixel value of the high-resolution image by using the FIR filter will be described. In the description of the basic action of this process, it is supposed that the super-resolution target region set in the actual low-resolution image is a 3×3 pixel region (see FIG. 3), and that the enlargement ratio of resolution of the high-resolution image with respect to the low-resolution image is two times both in the vertical and the horizontal directions, and that one high-resolution image is obtained from four actual low-resolution images. Each pixel value of the pixel in the region Rh on the high-resolution image is determined based on the pixel values of the pixels in the four super-resolution target regions set with respect to the four actual low-resolution images and the FIR filter (see FIG. 6).

Under this assumption, although being different from the description in “BACKGROUND OF THE INVENTION”, it is considered that the vector y is a vector of the pixel values of the pixels in four super-resolution target regions set with respect to the four actual low-resolution images, and that the vector x to be obtained from the vector y is a vector of pixel values of the pixels in the 6×6 pixel region (corresponding to the region Rh) on the high-resolution image. Therefore, since 4 (frames)×3 (pixels)×3 (pixels)=36, the vector y is a 36-dimensional vector having 36 pixel values as its vector elements. In addition, since 6 (pixels)×6 (pixels)=36, the vector x is also a 36-dimensional vector having 36 pixel values as its vector elements.

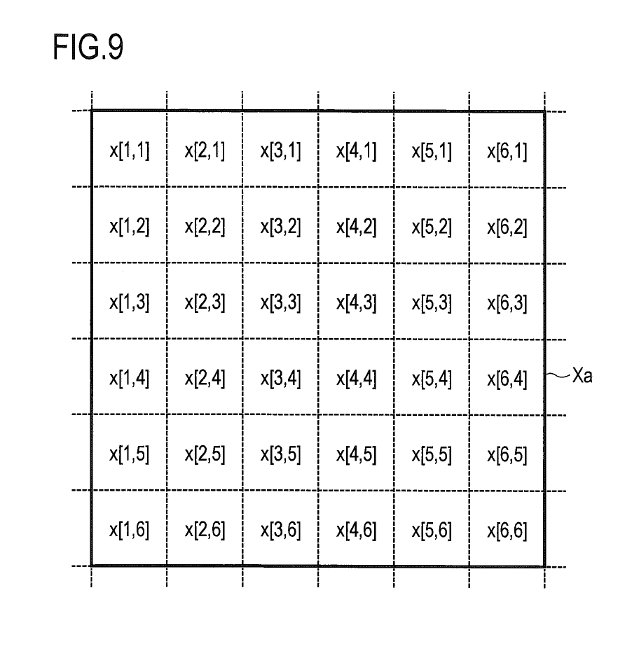

Then, the matrix expressed by the (A^{T}A+λP^{T}P)⁻¹A^{T} becomes a matrix having 36×36 elements, so the filter size of the FIR filter having the matrix elements as its filter factors is also 36×36. In other words, the FIR filter is made up of 36×36 matrix elements. The pixel values in the region Xa of the high-resolution image (corresponding to the region Rh in FIG. 6) are obtained based on the pixel values in the super-resolution target region Rt (see FIG. 3) having 3×3 pixels set in the actual low-resolution image. As shown in FIG. 9, the region Xa is a 6×6 pixel region made up of pixels x[1, 1] to x[6, 6]. When a certain noted pixel is denoted by x[p, q] and if p increases by one, the pixel position of the noted pixel moves in the right direction by one pixel. If q increases by one, the pixel position of the noted pixel moves in the downward direction by one pixel. Here, p and q are natural numbers. The pixels x[3, 3], x[3, 4], x[4, 3] and x[4, 4] in the region Xa correspond to the four pixels in the region Rh shown in FIG. 6 and are pixels on the high-resolution image corresponding to the super-resolution target pixel Gt on the actual low-resolution image (see FIG. 3).

When the vector having pixel values of pixels x[1, 1] to x[6, 6] (i.e., total 36 pixel values) in the region Xa as its elements is expressed by the vector x, the pixel values of the pixels x[3, 3], x[3, 4], x[4, 3] and x[4, 4] become respectively the 15th, the 16th, the 21st and the 22nd elements constituting the vector x. Therefore, in order to obtain the pixel values of the pixels x[3, 3], x[3, 4], x[4, 3] and x[4, 4], a sum of products should be calculated between the filter factors (elements) of the 15th line, the 16th line, the 21st line and the 22nd line in the FIR filter expressed by (A^{T}A+2P^{T}P)⁻¹A^{T} and the pixel values of the pixels in the super-resolution target regions in four actual low-resolution images (i.e., the elements of the vector y). For instance, a sum of products is calculated between the total 36 filter factors belonging to the 15th line of the FIR filter and 36 elements forming the vector y, so that the pixel value of the pixel x[3, 3] is obtained.

In this way, in order to obtain the high-resolution image by the super-resolution process using the FIR filter expressed by the (A^{T}A+λP^{T}P)⁻¹A^{T}, the filter factor on a specific line of the FIR filter should be calculated for each of the super-resolution target regions. The specific line means a line for calculating the pixel value of the pixel on the high-resolution image corresponding to the super-resolution target pixel among lines constituting the FIR filter. In the example described above, it corresponds to the 15th line, 16th line, 21st line and 22nd line. Since positions of the super-resolution target pixel and the super-resolution target region are changed sequentially by the raster scan, the filter factor on the specific line in the FIR filter is calculated every time when they are changed. Then, the sum of products between the filter factors on the specific line and the pixel values of the pixels in the super-resolution target regions in the four actual low-resolution images is determined, so as to determine the pixel value of the pixel on the high-resolution image corresponding to the super-resolution target pixel.

Although the super-resolution process based on the MAP (Maximum A Posterior) method is described above, it is possible to utilize another super-resolution process based on the ML (Maximum-Likelihood) method, the POCS (Projection Onto Convex Set) method or the IBP (Iterative Back Projection) method. For instance, while the super-resolution process using the repeating calculation is performed, the FIR filter for setting the repeating times to be two (which will be described later). In this case, it is possible to adopt the ML method without the normalization term (constrained term) by a prior probability model in order to determine the filter factor of the FIR filter easily, for instance.

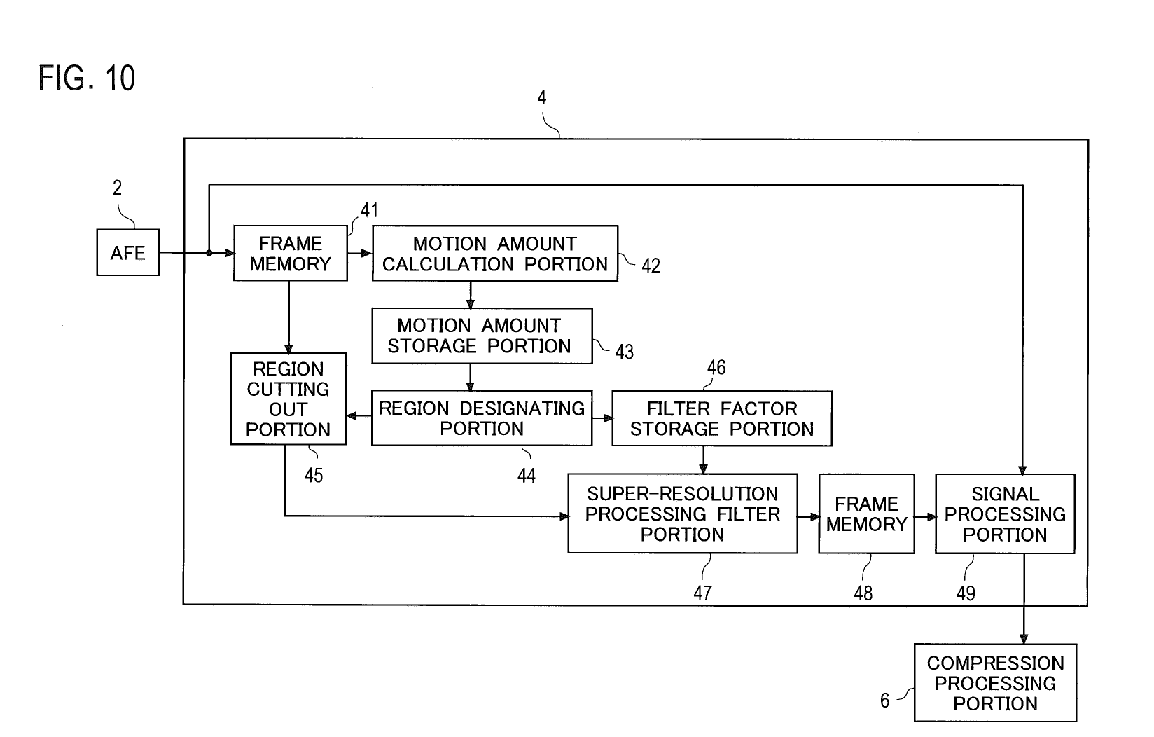

Methods for realizing concretely the super-resolution process as described above will be described as first to third examples. The items described above are applied to the first to the third examples appropriately. In the following description, it is supposed that the FIR filter for performing the super-resolution process is disposed in the image processing portion 4 and that the filter factors of the FIR filter are stored. The image processing portion 4 shown in FIG. 10 is described below as an example of a structure of the image processing portion 4. However, it is possible to adopt another structure different from that shown in FIG. 10 for the image processing portion 4, as long as corresponding pixel values of the pixels on the high-resolution image can be calculated for each of the super-resolution target regions set by the raster scan sequentially. For instance, the image processing portion 4 may be equipped with a circuit for performing the calculation based on the procedure described above with reference to FIGS. 8A to 8E, i.e., the calculation based on the process from the STEP 31 to the STEP 34, so that the high-resolution image can be obtained.

### FIRST EXAMPLE

A structure of the image processing portion 4 according to the first example of the present invention will be described with reference to FIG. 10. The FIG. 10 is a partial block diagram of the image sensing apparatus shown in FIG. 1 including the internal block diagram of the image processing portion 4 according to the first example.

The image processing portion 4 shown in FIG. 10 includes a frame memory 41 for temporarily storing the digital image signal indicating the actual low-resolution images of a plurality of frames received from the AFE 2, a motion amount calculation portion 42 for calculating an amount of motion between actual low-resolution images stored in the frame memory 41, a motion amount storage portion 43 for storing the amount of motion calculated by the motion amount calculation portion 42, a region designating portion 44 for designating a super-resolution target region in each of a plurality of actual low-resolution images to be used for the super-resolution process based on the amount of motion stored in the motion amount storage portion 43, a region cutting out portion 45 for reading out a pixel value of the super-resolution target region in each of the actual low-resolution images designated by the region designating portion 44 from the frame memory 41, a filter factor storage portion 46 for storing filter factors for performing the super-resolution process, a super-resolution processing filter portion 47 (hereinafter referred to as a filter portion 47 simply) for performing the super-resolution process by performing the filter process using the filter factors supplied from the filter factor storage portion 46 on the pixel value read out by the region cutting out portion 45, a frame memory 48 for storing the high-resolution image obtained by the filter process in the filter portion 47, and a signal processing portion 49 for generating a luminance signal and a color difference signal from an image signal indicating the high-resolution image stored in the frame memory 48 or an image signal supplied directly from the AFE 2.

The filter process in the filter portion 47 is realized by the FIR filter that is provided to the filter portion 47. In the first example, the FIR filter includes elements of the matrix expressed by (A^{T}A+λP^{T}P)⁻¹A^{T} as its filter factors.

When the high-resolution image is generated based on the actual low-resolution images of the plurality of frames from the AFE 2 in the image processing portion 4 having the structure described above, each of the blocks disposed in the image processing portion 4 works, so that the super-resolution process is performed for each of the super-resolution target regions as described above. In order to realize this operation, the pixel values of the actual low-resolution images of a plurality of frames are read out from the frame memory 41 for each of the super-resolution target regions, which will be described later in detail.

In this case, the filter factors corresponding to the amount of motion between the super-resolution target regions of different frames are given to the filter portion 47 by the filter factor storage portion 46. The filter process based on the given filter factors is performed on the pixel values read out from the frame memory 41, so that the super-resolution process is performed for each of the super-resolution target regions. Then, the pixel values obtained by the super-resolution process is performed for each of the super-resolution target regions are supplied to the frame memory 48 and are stored in the same as the pixel values of pixels in the high-resolution image.

If the operation for requesting the high resolution processing on the image is not given to the operating portion 15, the image signal converted into the digital signal in the AFE 2 is supplied to the signal processing portion 49 one by one frame. Then, the signal processing portion 49 generates the luminance signal and the color difference signal from the supplied image signal. Then, the obtained luminance signal and the color difference signal are supplied to the compression processing portion 6 one by one flame so that the compression processing portion 6 performs a compressing and coding process of the signals.

[Detection of Amount of Motion]

As to the image processing portion 4 having the structure shown in FIG. 10, it is supposed that one high-resolution image is generated from F actual low-resolution images. Here, F is an integer of two or larger, and it is supposed that F is three or larger as a rule in the description below. One actual low-resolution image is selected as the datum frame among F actual low-resolution images stored in the frame memory 41, and each of the other (F−1) actual low-resolution images is selected as the consulted frame. The motion amount calculation portion 42 detects the amount of motion between the datum frame and each of the consulted frames based on the F actual low-resolution images stored in the frame memory 41.

The first, the second . . . the (F−1)th and the F-th actual low-resolution images arranged in time series are obtained sequentially, and the motion amount calculation portion 42 first handles the one of the two actual low-resolution images that are adjacent on the time base as a reference image and the other as a non-reference image. Then, the motion amount calculation portion 42 detects the amount of motion between the two actual low-resolution images that are adjacent on the time base (i.e., detects the amount of motion between the neighboring frames). This detection is performed sequentially with respect to between the first and the second actual low-resolution images, between the second and the third actual low-resolution images, . . . , and between the (F−1)th and the F-th actual low-resolution images. Next, a sum of the detected amounts of motion is determined so that the amount of motion between two actual low-resolution images that are not adjacent on the time base is determined. Thus, the amount of motion between the datum frame and each of the consulted frames can be detected. For instance, if the datum frame is the first actual low-resolution image and if the amount of motion between the actual low-resolution image as the datum frame and the third actual low-resolution image as the consulted frame is to be determined, a sum of the amount of motion between the first and the second actual low-resolution images and the amount of motion between the second and the third actual low-resolution image should be determined.

Note that it is possible to handle the actual low-resolution image that is the datum frame as the reference image and to handle any actual low-resolution image that is the consulted frame as the non-reference image, and then to determine the amount of motion between the reference image and the non-reference image so that the amount of motion between the datum frame and each of the consulted frames can be determined directly.

The motion amount calculation portion 42 detects the amount of motion between the reference image and the non-reference image forming the two actual low-resolution images that are adjacent on the time base, and objects of the detection includes the amount of motion in the translational direction and the amount of motion in the rotational direction. It is possible to adopt any known method as the method of detecting the amount of motions in the translational and the rotational directions.

The amount of motion to be detected has a resolution of a so-called sub pixel that is higher than the resolution of pixel interval of the actual low-resolution image. In other words, the amount of motion is detected with a minimum unit of distance shorter than the space between two neighboring pixels in the actual low-resolution image. Therefore, the process for detecting the amount of motion between the reference image and the non-reference image can be considered to include a motion amount detection process with a pixel unit and a motion amount detection process with a sub pixel unit. It is possible to perform the latter process after the former process by using a result of the former process. As the method of the motion amount detection process with a pixel unit and the motion amount detection process with the sub pixel unit, any known method can be adopted. An example of the processes is as described below. Note that the amount of motion to be detected in the example of the motion amount detection processes with a pixel unit and with a sub pixel unit described below is the amount of motion in the translational direction. In order to detect the amount of motion in the rotational direction between the reference image and the non-reference image, the method described in JP-A-11-195125 should be used, for instance.

Motion Amount Detection Process with Pixel Unit

In the motion amount detection process with a pixel unit, a well-known image matching method is used for detecting the amount of motion of the non-reference image with respect to the reference image with a pixel unit. As an example, a case of using a representative point matching method will be described. Of course, it is possible to use a block matching method or the like.

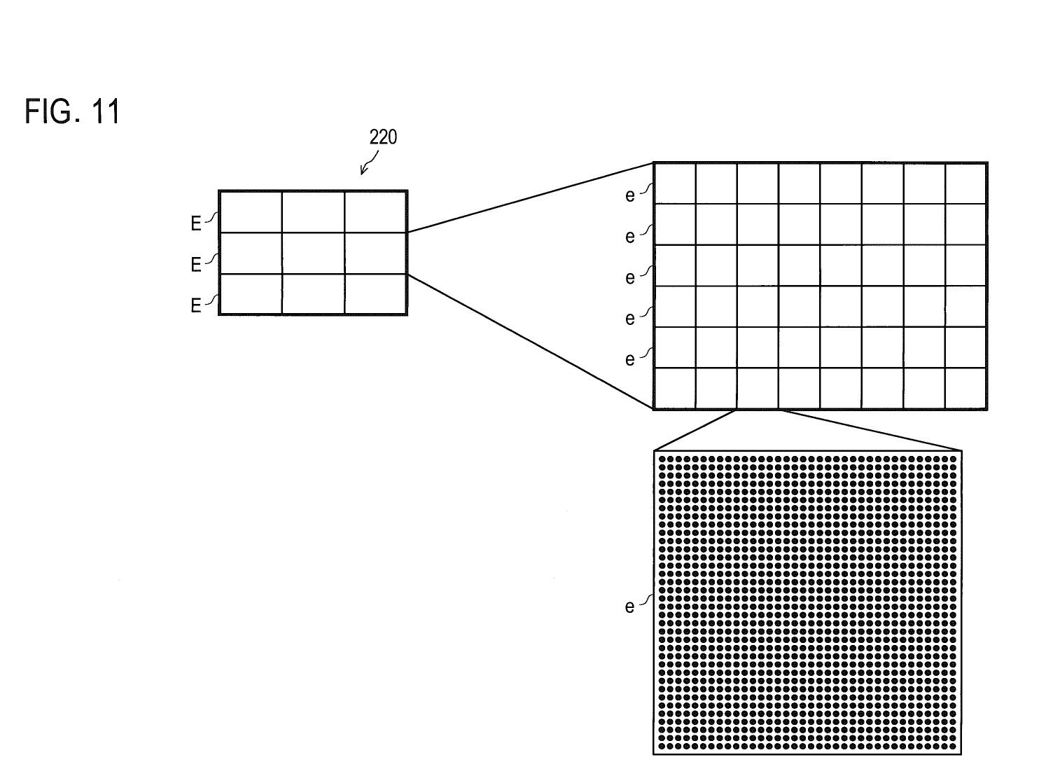

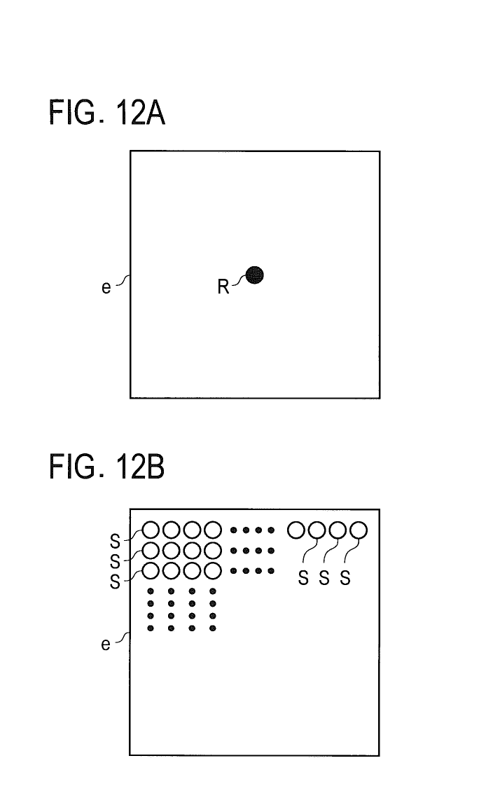

FIG. 11 is referred to. In FIG. 11, the image 220 indicates the reference image or the non-reference image. A plurality of detection regions E are disposed in the image 220. For instance, the entire region of the image 220 is divided equally by three in each of the vertical direction and the horizontal direction, so that total nine detection regions E are formed. Each of the detection regions E is further divided into a plurality of small regions e. In the example shown in FIG. 11, each of the detection regions is divided into 48 small regions e (divided by six in the vertical direction and by eight in the horizontal direction). Each of the small regions e is made up of pixels arranged in a two-dimensional manner (e.g., pixels arranged in a two-dimensional manner of 36 pixels in the vertical direction and 36 pixels in the horizontal direction). Then, as shown in FIG. 12A, one pixel is set as the representative point R in each of the small regions e in the reference image. On the other hand, as shown in FIG. 12B, a plurality of pixels are set as a plurality of sampling point S in each of the small regions e in the non-reference image (every pixel in the small region e may be set as the sampling point S).

After setting the detection region E and the small region e in this way, an SAD (Sum of Absolute Difference) or an SSD (Sum of Square Difference) of the pixel value (luminance value) between the reference image and the non-reference image is calculated for each of the detection regions in accordance with the representative point matching method. Using a result of this calculate, a sampling point S having the highest correlation with the representative point R is determined for each of the detection regions, and a position variation quantity of the sampling point S with respect to the representative point R is determined with a pixel unit. Then, a mean value of the position variation quantity determined for each of the detection regions is detected as the amount of motion between the reference image and the non-reference image with a pixel unit.

More specifically, the following processes are performed. The small region e in the reference image and a small region e in the non-reference image that is located at the same position as the position of the small region e are noted. Then, a difference between a pixel value of the representative point R in the noted small region e in the reference image and a pixel value of the sampling point S in the noted small region e in the non-reference image is determined as a correlation value for each of the sampling points S. After that, the correlation values with respect to the sampling points S having the same relative position to the representative point R are added cumulatively by the small region e belonging to the detection region E for each of the detection regions E. If the number of the small regions e belonging to one detection region E is 48, the 48 correlation values are added cumulatively so that one cumulative correlation value is determined with respect to one sampling point S. The cumulative correlation values of the number corresponding to the number of sampling points S set in one small region e are determined for each of the detection regions E.

In this way, after a plurality of cumulative correlation values are determined for each of the detection regions E (i.e., the cumulative correlation values with respect to each of the sampling points S), a minimum value among the plurality of cumulative correlation values is detected for each of the detection regions E. The correlation between the representative point R and the sampling point S corresponding to the minimum value is considered to be higher than correlations with respect to other sampling points S. Therefore, the position variation quantity between the representative point R and the sampling point S corresponding to the minimum value is detected as the amount of motion with respect to the noted detection region E. This detection is performed for each of the detection regions E. The amounts of motion found one for each detection region E are averaged to obtain an average value, which is detected as the amount of motion with a pixel unit between the reference image and the non-reference image.

Motion Amount Detection Process with Sub Pixel Unit

After the amount of motion with a pixel unit is detected, the amount of motion with a sub pixel unit is further detected. The sampling point S having the highest correlation with the representative point R determined by the above-mentioned representative point matching method is denoted by S_{X}. Then, the amount of motion with a sub pixel unit is determined for each of the small regions e based on pixel value of the pixel at the representative point R in the reference image, and pixel values of the pixel at the sampling point S_{X} and the surrounding pixels in the non-reference image, for instance.

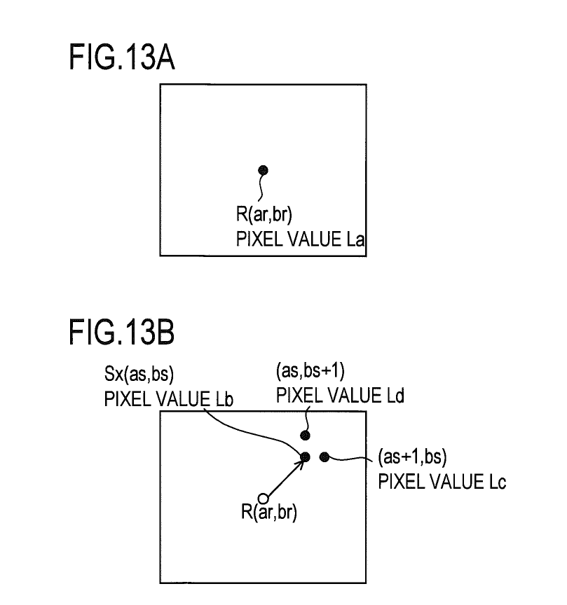

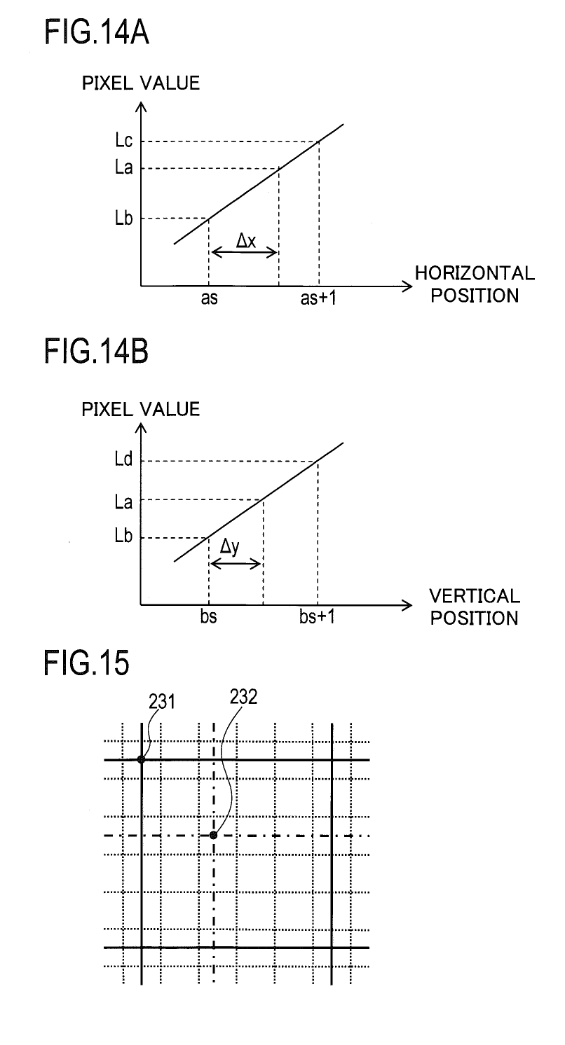

This process will be described with reference to FIGS. 13A, 13B, 14A and 14B. It is supposed that the representative point R is disposed at the pixel position (ar, br) in the reference image, and a pixel value at the representative point R is denoted by La (see FIG. 13A). It is supposed that the sampling point S_{X} is disposed at the pixel position (as, bs) in the non-reference image, and a pixel value at the sampling point S_{X} is denoted by Lb (see FIG. 13B). Further, a pixel value at the pixel position (as+1, bs) adjacent to the sampling point S_{X} in the horizontal direction (the right direction in FIG. 13B) in the non-reference image is denoted by Lc, and a pixel value at the pixel position (as, bs+1) adjacent to the sampling point S_{X} in the vertical direction (the upward direction in FIG. 13B) in the non-reference image is denoted by Ld. In this case, the amount of motion between the reference image and the non-reference image with a pixel unit is expressed by a vector quantity (as−ar, bs−br).

In addition, it is supposed that the pixel value changes linearly from Lb to Lc when the pixel position moves from the sampling point S_{X} in the horizontal direction by one pixel as shown in FIG. 14A, and that the pixel value changes linearly from Lb to Ld when the pixel position moves from the sampling-point S_{X} in the vertical direction by one pixel as shown in FIG. 14B. On this assumption, a position (as+Δx) in the horizontal direction where the pixel value becomes La between the pixel positions (as, bs) and (as+1, bs) is determined. In addition, a position (bs+Δy) in the vertical direction where the pixel value becomes La between the pixel positions (as, bs) and (as, bs+1) is determined. Here, Δx and Δy are derived from the equations “Δx=(La−Lb)/(Lc−Lb)” and “Δy=(La−Lb)/(Ld−Lb)”. The calculation of Δx and Δy is performed for each of the small regions e, a vector quantity expressed by (Δx, Δy) is determined as the amount of motion with a sub pixel unit in the small region e.

After that, the amounts of motion with a sub pixel unit determined for the small regions e are averaged, and the amount of motion obtained by the averaging process is detected as the amount of motion with a sub pixel unit between the reference image and the non-reference image. Then, the amount of motion with a sub pixel unit between the reference image and the non-reference image is added to the amount of motion with a pixel unit between the reference image and the non-reference image, and the sum is detected as the amount of motion between the reference image and the non-reference image to be obtained finally.

Using the method described above, the amount of motion between the two actual low-resolution images that are adjacent on the time base is detected. If the amount of motion between a certain actual low-resolution image and the actual low-resolution image as the datum frame that is not adjacent to it on the time base is to be determined, a sum of the amounts of motion with respect to a plurality of actual low-resolution images obtained while the both images are obtained should be determined as described above. The amount of motion between the datum frame and each of the consulted frames determined as described above is supplied to the motion amount storage portion 43 shown in FIG. 10 and is stored in the same. Note that the concrete method of the motion amount detection process described above is merely an example. It is possible to adopt any other method as long as the amount of motion can be detected with a sub pixel resolution. The other method may be used for detecting the amount of motion between the actual low-resolution image as the datum frame and another actual low-resolution image.

[Region Designation]

When the motion amount calculation portion 42 determines the amount of motion between the datum frame and each of the consulted frames as described above, the region designating portion 44 shown in FIG. 10 sets the super-resolution target region in the image region of the actual low-resolution image as the datum frame stored in the frame memory 41. In other words, it designates a position of the super-resolution target region in the datum frame. After that, the region designating portion 44 designates a position of the super-resolution target region in the consulted frame corresponding to the super-resolution target region in the datum frame for each of the consulted frames. This designation is performed based on the amount of motion stored in the motion amount storage portion 43 so that a size of the amount of motion (position error amount) between the super-resolution target region in the datum frame and the super-resolution target region in the consulted frame becomes smaller than a size of one pixel in the actual low-resolution image. More specifically, the position of the super-resolution target region in the consulted frame is designated based on the amount of motion stored in the motion amount storage portion 43 so that the super-resolution target region in the datum frame and the super-resolution target region in the consulted frame have an overlapping area as large as possible.

Hereinafter, it is supposed in the first example that four actual low-resolution images Fa, Fb, Fc and Fd are stored in the frame memory 41, and that the actual low-resolution image Fa is handled as the datum frame while the actual low-resolution images Fb, Fc and Fd are each handled as the consulted frame so that one high-resolution image is generated. In this case, the motion amount storage portion 43 stores the amounts of motion between image Fa and each of the images Fb, Fc and Fd. When the super-resolution target region is set on the image Fa, the super-resolution target regions on the images Fb, Fc and Fd are set at positions such that they overlap with the super-resolution target region on the image Fa.

In this case, the region designating portion 44 performs the alignment between the image Fa and each of the images Fb, Fc and Fd based on the amount of motion between the image Fa and each of the images Fb, Fc and Fd with respect to the image Fa. More specifically, since the image Fb can be regarded as an image having a position error (displacement) corresponding to the amount of motion between the images Fa and Fb with respect to the image Fa, coordinate values of pixels on the image Fb are converted into coordinate values on the image Fa by a geometric conversion so that the position error is canceled (the same is true on the images Fc and Fd). This conversion realizes the alignment. In this way, the alignment is performed on the actual low-resolution images Fb, Fc and Fd with respect to the image Fa based on the amounts of motion stored in the motion amount storage portion 43, so that the positions of the super-resolution target regions on the images Fb, Fc and Fd are specified, which should be set corresponding to the super-resolution target region set on the image Fa. In other words, it is possible to recognize the positions of the super-resolution target regions on the images Fb, Fc and Fd, each of which has the amount of motion smaller than one pixel between itself and the super-resolution target region on the image Fa.

As described above in “Basic action of the super-resolution process”, the position of the super-resolution target region set on the image Fa is changed sequentially by the raster scan, so the positions of the super-resolution target regions on the images Fb, Fc and Fd are also changed along with the change of the super-resolution target region set on the image Fa. However, as described above, when the position of the super-resolution target region on the image Fa is scanned in the horizontal direction, the position of the super-resolution target region on the image Fb, Fc or Fd can move not only in the horizontal direction but also in the vertical direction.

In this way, the region designating portion 44 designates the super-resolution target region for performing the super-resolution process with reference to each of the F actual low-resolution images (F=4 in this example) stored in the frame memory 41. On this occasion, the region address in the frame memory 41 storing the pixel value of the pixel in the designated super-resolution target region is set. The region designating portion 44 informs the region cutting out portion 45 about the region address set for each of the F actual low-resolution images.

The region cutting out portion 45 reads out the pixel value stored in the region address from the frame memory 41, so as to read out the pixel value of the pixel in the super-resolution target region in each of the F actual low-resolution images to be used for the super-resolution process. In other words, the region cutting out portion 45 reads out the pixel value of the pixel in the super-resolution target region in each of the images Fa to Fd.

The above description of “Basic action of the super-resolution process” exemplifies that the super-resolution target region is a 3×3 pixel region, but accuracy of the super-resolution process is insufficient with the 3×3 pixel region size. In order to enhance the accuracy of the super-resolution process to a sufficient extent, it is necessary to increase the size of the super-resolution target region to a size of approximately a 10×10 pixel to 20×20 pixel region. If the super-resolution target region set for each of the images Fa to Fd is a 10×10 pixel to 20×20 pixel region, the region cutting out portion 45 will read out 400 to 1600 pixel values at one time from the frame memory 41. In the following description of the first example, it is supposed appropriately that the super-resolution target region is a 10×10 pixel region.

[Setting of Filter Factor]

As described above, the region designating portion 44 designates the region address in the frame memory 41 storing the pixel value to be read out from the frame memory 41 by the region cutting out portion 45. On this occasion, the alignment between the actual low-resolution images is performed as described above based on the amounts of motion stored in the motion amount storage portion 43. Then, the super-resolution target region is set for each of the actual low-resolution images after the alignment, so that a size of the amount of motion (position error amount) between the super-resolution target regions becomes smaller than a size of one pixel on the actual low-resolution image.

The region designating portion 44 confirms the amount of motion between the super-resolution target region in the datum frame and the super-resolution target region in the consulted frame generated after the alignment, i.e., a position error amount between the position (center position) of the super-resolution target region in the datum frame and the position (center position) of the super-resolution target region in the consulted frame. A size of this amount of motion is smaller than a size of one pixel on the actual low-resolution image as described above. Hereinafter, the amount of motion (position error amount) between the super-resolution target region in the datum frame and the super-resolution target region in the consulted frame generated after the alignment is referred to as an “amount of motion smaller than one pixel between the super-resolution target regions”. The amount of motion smaller than one pixel between the super-resolution target regions is transmitted to the filter factor storage portion 46. Based on the amount of motion smaller than one pixel between the super-resolution target regions that is confirmed by the region designating portion 44, a filter factor corresponding to the amount of motion is read out from the filter factor storage portion 46. Then, the read out filter factor is supplied to the filter portion 47 as a filter factor of the FIR filter to be used for the super-resolution process (hereinafter also referred to an FIR filter factor).

It is supposed that the super-resolution target region is an M×N pixel region and that the enlargement ratios of the resolution of the high-resolution image with respect to the low-resolution image are V and H times in the vertical and horizontal directions, respectively. Then, the FIR filter to be used for the super-resolution process is a filter expressed by a matrix of (M×N×F)×(M×V×N×H). Here, M and N are natural numbers, which are usually integers of three or larger. In addition, V and H satisfy “V>1” and “H>1”, which are typically integers of two or larger, for instance. Furthermore, F indicates the number of actual low-resolution images to be used for the super-resolution process as described above. Then, if the pixel in the Mx×Nx pixel region positioned at the middle of the super-resolution target region in the actual low-resolution image as the datum frame is regarded as the super-resolution target pixel, the pixels in the high-resolution image corresponding to the super-resolution target pixel is to be positioned in a (Mx×V)×(Nx×H) pixel region (Mx and Nx are integers of one or larger).

Therefore, the filter portion 47 is not required to perform the calculation by using all the (M×N×F)×(M×V×N×H) filter factors constituting the FIR filter as described above in “Basic concept of super-resolution process”. Instead, the filter portion 47 should use (M×N×F)×(Mx×V)×(Nx×H) FIR filter factors for calculating pixel values in the (Mx×V)×(Nx×H) pixel region on the high-resolution image from (M×N×F) pixel values on the F actual low-resolution images.

On the other hand, concrete values of the (M×N×F)×(Mx×V)×(Nx×H) FIR filter factors should be changed corresponding to the amount of motion smaller than one pixel between the super-resolution target regions. In addition, if the F actual low-resolution images include the images Fa and Fb, Fc and Fd as described above, there are the amount of motion m_{ab} smaller than one pixel between the super-resolution target regions with respect to the images Fa and Fb, the amount of motion m_{ac} smaller than one pixel between the super-resolution target regions with respect to the images Fa and Fc and the amount of motion m_{ad} smaller than one pixel between the super-resolution target regions with respect to the images Fa and Fd as the amount of motion smaller than one pixel between the super-resolution target regions. Therefore, values corresponding to the amounts of motion m_{ab}, m_{ac} and m_{ad} are stored in the filter factor storage portion 46 as the (M×N×F)×(Mx×V)×(Nx×H) FIR filter factors for calculating the pixel values of the pixels on the high-resolution image corresponding to the super-resolution target pixel. When the filter factor storage portion 46 recognizes a combination of the amounts of motion m_{ab}, m_{ac} and m_{ad}, (M×N×F)×(M×V)×(Nx×H) FIR filter factors corresponding to the combination is read out.

Therefore, if “M=N=10”, “F=4”, “V=2” and “H=2” hold, for instance, the FIR filter of the filter portion 47 is made up of 400×400 (=(10×10×4)×(10×2×10×2)) filter factors. In addition, if the super-resolution target pixel in the image Fa as the datum frame is one pixel, the pixels on the high-resolution image corresponding to the super-resolution target pixel are positioned in a 2×2 pixel region.

As understood from the above description, if “M=N=10, F=4, V=2 and H=2” holds, the pixel values of the pixels on the high-resolution image corresponding to the super-resolution target pixel can be calculated by determining a sum of products between pixel values of total 400 pixels in the super-resolution target regions in the images Fa to Fd and the filter factors (elements) on a specific line of the FIR filter. Here, the specific line means a line in the FIR filter storing the filter factors with respect to four pixels on the high-resolution image corresponding to the super-resolution target pixel. Therefore, as to the FIR filter of the filter portion 47, the number of filter factors necessary for calculating the pixel values of the pixels on the high-resolution image corresponding to the super-resolution target pixel is 1600 (400×4 lines) since the number of filter factors belonging to one line is 400. Therefore, if “M=N=10, F=4, V=2 and H=2” holds, the filter portion 47 is provided with 1600 filter factors.

In addition, since the super-resolution target region is designated after the alignment between the actual low-resolution images, the amount of motion between the super-resolution target regions is sufficiently small even if the amount of motion between the actual low-resolution images is large. In addition, since the super-resolution target region is a region that is sufficiently smaller than the entire image region of the actual low-resolution image, the rotational component of the amount of motion between the super-resolution target regions becomes very small even if the amount of motion between the actual low-resolution images includes a rotational component that cannot be omitted. Therefore, the amount of motion between the super-resolution target regions can be regarded to have only the translational component.

In summary, a size of the amount of motion between the super-resolution target regions of the datum frame and any one of the consulted frames is smaller than a size of one pixel on the actual low-resolution image (more specifically, sizes of the horizontal component and the vertical component of the amount of motion between the super-resolution target regions are smaller than sizes of one pixel in the horizontal and the vertical directions on the actual low-resolution image, respectively). Further, the amount of motion between the super-resolution target regions of the datum frame and any one of the consulted frames can be regarded to have only the translational component.

Therefore, a positional relationship between the super-resolution target region in the datum frame and the super-resolution target region in the consulted frame can be defined only by the horizontal component and the vertical component of the amount of motion between the super-resolution target regions. In addition, sizes of the horizontal component and the vertical component of the amount of motion can be detected by digitizing them by α and β steps, respectively. More specifically, as shown in FIG. 15, the image region of one pixel in the actual low-resolution image as the datum frame is divided by α and β in the vertical direction and in the horizontal direction, respectively. Then, the amount of motion between the super-resolution target regions can be expressed by using coordinate positions of α×β split regions obtained by the division. Here, α and β are integers of two or larger. In the example shown in FIG. 15, α and β can be considered to be five. In FIG. 15, the solid lines indicate a contour of the pixel of the datum frame, the dashed dotted line indicate a contour of the pixel of the consulted frame, the point 231 indicates an upper left corner of the super-resolution target region in the datum frame, and the point 232 indicates an upper left corner of the super-resolution target region in the consulted frame. The broken lines in FIG. 15 are boundary lines between neighboring split regions. In the example shown in FIG. 15, the point 232 is shifted in the right direction by two split regions and is shifted in the downward direction by two split regions with respect to the point 231. Therefore, it can be regarded that the horizontal coordinate value and the vertical coordinate value of the point 232 are both ⅖ when the point 231 is the origin.

When the quantization as shown in FIG. 15 is used, there are (α×β) combinations concerning the overlapping manner between the super-resolution target regions of the two actual low-resolution images, i.e., concerning the positional relationship between the super-resolution target regions of the two actual low-resolution images. Therefore, considering simply, there are (α×β)^{F-1} combinations concerning the positional relationship between the super-resolution target regions of F actual low-resolution images. However, the same combination can be made by swapping (F−1) consulted frames with each other. In other words, there are (F−1)! combinations of redundancy. Taking this redundancy into account, the number of combinations concerning the positional relationship between the super-resolution target regions of the F actual low-resolution images is “(α×β)^{F-1}/(F−1)!”. In other words, the positional relationship between the super-resolution target regions of the F actual low-resolution images can be classified into (α×β)^{F-1}/(F−1)! types. Note that “(F−1)! ” means the factorial of (F−1).

Therefore, if “F=4” and “α=β=5” hold like the example shown in FIG. 15, the number of combinations concerning the positional relationship between the super-resolution target regions of the F actual low-resolution images becomes 25³/(3×2×1). The filter factor storage portion 46 stores the FIR filter factor to be supplied to the filter portion 47 for each of the combinations concerning the positional relationship. In addition, if “M=N=10, F=4, V=2 and H=2” holds, the number of the FIR filter factors supplied to the filter portion 47 is 1600 as described above. Therefore, if two bytes of memory capacity is used for a value of one filter factor, the filter factor storage portion 46 needs approximately 8.3 megabytes of memory capacity for storing the FIR filter factors of all the combinations. If the above-mentioned redundancy is not taken into account, the filter factor storage portion 46 needs approximately 50 megabytes of memory capacity.

In this way, the filter factor storage portion 46 stores FIR filter factors corresponding to combinations of the amount of motion between the super-resolution target regions of the F actual low-resolution images (in other words, combinations of the positional relationship between the super-resolution target regions of the F actual low-resolution images). The region designating portion 44 calculates the amount of motion between the super-resolution target regions of the datum frame and each of the consulted frames. When they are supplied to the filter factor storage portion 46, the FIR filter factor corresponding to the combination of the amount of motion is read out from the filter factor storage portion 46 and is supplied to the filter portion 47.

In this case, if the filter factor storage portion 46 stores the FIR filter factors considering the redundancy of the positional relationship in the super-resolution target regions between the consulted frames, the order of lines to which the read-out FIR filter factors should be assigned in accordance with the combination of the amounts of motion may be changed into one corresponding to the order of the actual low-resolution images to be supplied to the filter portion 47. In addition, instead of changing the order of the FIR filter factors, the order of the actual low-resolution images to be supplied to the filter portion 47 may be changed in accordance with the arrangement of the read-out FIR filter factors.

On the other hand, if the redundancy of the positional relationship in the super-resolution target regions between the consulted frames is not taken into account concerning the FIR filter factors stored in the filter factor storage portion 46, the FIR filter factors to be used is determined uniquely to the combination of the positional relationship (combination of the amounts of motion). In this case, therefore, the FIR filter factors are stored in the filter factor storage portion 46 for each of the combinations, and the FIR filter factor that is unique to the combination of the amounts of motion is read out from the filter factor storage portion 46 and is supplied to the filter portion 47 with respect to every combination of the amounts of motion indicating the positional relationship of the super-resolution target regions between the consulted frames.

[Super-Resolution Calculation Process]

When the FIR filter factors stored in the filter factor storage portion 46 are supplied to the filter portion 47, necessary FIR filter factors are supplied to the filter portion 47 among the FIR filter factors constituting the above-mentioned FIR filter expressed by (A^{T}A+λP^{T}P)⁻¹A^{T}. The necessary FIR filter factors mean FIR filter factors necessary for calculating the pixel values of the pixels disposed at the pixel position on the high-resolution image corresponding to the pixel position of the super-resolution target pixel, which correspond to the filter factors on the above-mentioned specific line. On the other hand, pixel values of the super-resolution target region corresponding to the region address designated by the region cutting out portion 45 are supplied to the filter portion 47 sequentially from the frame memory 41, and the filter portion 47 calculates the sum of products between the supplied pixel values and the filter factors from the filter factor storage portion 46.

More specifically, the filter portion 47 performs the calculation according to the above equation (A7), i.e., the equation “x=(A^{T}A+λP^{T}P)⁻¹A^{T}y” with respect to the super-resolution target regions of the actual low-resolution images, so as to calculate the pixel value x of the high-resolution image. Here, y is the pixel values of the pixels in the super-resolution target regions set with respect to the images Fa and Fb, Fc and Fd, which are made to be a vector, and x is the pixel values of the pixels on the high-resolution image corresponding to the super-resolution target pixel, which are made to be a vector. Upon this calculation, the FIR filter factors supplied to the filter portion 47 from the filter factor storage portion 46 are the above-mentioned necessary filter factors. In other words, only the FIR filter factors with respect to the line corresponding to the pixels arranged at the pixel positions on the high-resolution image corresponding to the super-resolution target pixel are supplied to the filter portion 47. The pixel values of the high-resolution image calculated in this way are supplied to the frame memory 48 and are stored in the same. On this occasion, the address position on the frame memory 48 is designated so that the calculated pixel value is stored at the address position corresponding to the pixel position, at which the pixel value is calculated, on the high-resolution image.

Note that since the amount of motion indicating the positional relationship between the super-resolution target regions is detected by quantization as shown in FIG. 15, the FIR filter factors stored in the filter factor storage portion 46 have discrete values with respect to the amount of motion between the super-resolution target regions. Although the FIR filter factors from the filter factor storage portion 46 having such characteristics are used as they are for performing the calculation by the FIR filter in the example described above, it is possible to change the FIR filter factors continuously in accordance with the amount of motion between the super-resolution target regions.

In order to realize this method, the following process is performed, for instance. The amount of motion indicating the positional relationship between the super-resolution target regions is detected with a unit of the split region shown in FIG. 15 while it is also detected with a unit of region smaller than the split region shown in FIG. 15. Then, bilinear interpolation of the digitized FIR filter factors stored in the filter factor storage portion 46 is performed based on a result of the detections described above using a bilinear method or the like. Thus, the FIR filter factors that are optimal for the amount of motion between the super-resolution target regions are generated. This process enables to generate the FIR filter factors changing continuously in accordance with the amount of motion between the super-resolution target regions from the digitized FIR filter factors stored in the filter factor storage portion 46. If the generated filter factors are used for the FIR filter of the filter portion 47 for performing the filter process, the high-resolution image stored in the frame memory 48 can have higher definition.

The above-mentioned operations of individual blocks in the image processing portion 4 shown in FIG. 10 are performed every time when the position of the super-resolution target region is changed by the raster scan. When the super-resolution target regions in the datum frame and the consulted frame exist in the first and the second positions respectively, the FIR filter factors in accordance with the positional relationship between the first and the second positions are supplied to the filter portion 47 from the filter factor storage portion 46, so that pixel values of the high-resolution image are calculated by using the FIR filter factors. After that, if the super-resolution target regions in the datum frame and the consulted frame move from the first and the second positions to the third and the fourth positions respectively by the raster scan, the FIR filter factors in accordance with the positional relationship between the third and the fourth positions are supplied to the filter portion 47 from the filter factor storage portion 46, so that pixel values of the high-resolution image are calculated by using the FIR filter factors.

This process is performed repeatedly, so that pixel values of the pixel positions on the high-resolution image corresponding to the super-resolution target pixel are obtained in turn. Then, if the above-mentioned calculation process is fished for every pixel in the datum frame as the super-resolution target pixel, the pixel values of all the pixels constituting the high-resolution image are obtained and are stored in the frame memory 48.

When the high-resolution image is stored in the frame memory 48, the image signal based on the pixel values of the high-resolution image stored in the frame memory 48 is supplied to the signal processing portion 49. The signal processing portion 49 generates the luminance signal and the color difference signal from the image signal indicating the supplied one frame of high-resolution image and sends them to the compression processing portion 6.

### SECOND EXAMPLE

Next, a second example of the present invention will be described. The structure of the image processing portion 4 according to the second example of the present invention is the same as that shown in FIG. 10. However, the method of the super-resolution process adopted for the image processing portion 4 in the second example is different from that in the first example. Noting the difference between the first and the second examples, an action of the image processing portion 4 according to the second example will be described.

As described above in “Basic concept of super-resolution process”, when the reconstruction type super-resolution process is performed by the repeating calculation (repeating computational algorithm), the original low-resolution images are estimated from the high-resolution image that is once estimated. Then, the high-resolution image is reconstructed based on a difference between the estimated low-resolution images and the actual low-resolution images so that a value of the derivative ∂E[x]/∂x of the evaluation function E[x] becomes close to zero. Therefore, instead of using the FIR filter expressed by (A^{T}A+λP^{T}P)⁻¹A^{T} in the filter portion 47 as shown in the first example, it is possible to use factors corresponding to the repeating calculation by the reconstruction type super-resolution process as the filter factors of the FIR filter.

The second example exemplifies the case where the FIR filter to be used in the filter portion 47 is made up of factors that are obtained by repeating the calculation by the reconstruction type super-resolution process two times. The following description will be performed by noting a relationship between the FIR filter in this example and the calculation by the reconstruction type super-resolution process. Furthermore, it is supposed in the following description of the second example that one high-resolution image is generated from three actual low-resolution images Fa, Fb and Fc (therefore, F=3), and that the actual low-resolution image Fa is the datum frame.

In the super-resolution process according to the second example, a gradient as the derivative ∂E[x]/∂x of the evaluation function E[x] is calculated based on the high-resolution image Fx1 set initially by the actual low-resolution images Fa, Fb and Fc, and the actual low-resolution images Fa, Fb and Fc. More specifically, the gradient ∂E[x]/∂x based on the square errors between the estimated low-resolution images Fa1, Fb1 and Fc1 estimated by the high-resolution image Fx1 and the actual low-resolution images Fa, Fb and Fc is calculated in accordance with the equation (A8) below. Here, a pixel value of the high-resolution image Fx1 expressed as a vector is denoted by “x”, and pixel values of the actual low-resolution images Fa, Fb and Fc expressed as a vector is denoted by “y”.

∂E[x]/∂x=2A^{T}(Ax−y)+2λP^{T}Px (A8)

Then, a pixel value x1 (=x−∂E[x]/∂x) of a new high-resolution image Fx2 is determined based on this gradient ∂E[x]/∂x. Note that “x1” denotes a pixel value of the high-resolution image Fx2 expressed in a vector. In addition, using the pixel value x1 of the high-resolution image Fx2 determined in this way, a gradient a E[x1]/∂x based on the pixel value y of the actual low-resolution images Fa, Fb and Fc is calculated in accordance with the equation (A9) below. When this gradient a E[x1]/∂x is subtracted from the pixel value x1 of the high-resolution image Fx2, the pixel value x2 (=x1−∂E[x1]/∂x) of the high-resolution image Fx3 by two times of updating actions is obtained. Note that “x2” denotes a pixel value of the high-resolution image Fx3 expressed in a vector.

∂E[x1]/∂x=2A^{T}(Ax1−y)+2λP^{T}Px1 (A9)

The FIR filter for performing this calculation is provided to the filter portion 47 according to the second example. Hereinafter, the calculation method of the FIR filter factor constituting the FIR filter will be described with reference to the drawings. Furthermore, it is supposed for a simple description below that the high-resolution image having resolution two times higher than the resolution of the actual low-resolution image in each of the horizontal and the vertical directions is generated by the super-resolution process (i.e., H=V=2). In addition, it is supposed that each of the actual low-resolution images Fb and Fc selected as the consulted frames from three actual low-resolution images stored in the frame memory 41 has a position error with respect to the actual low-resolution image Fa as the datum frame in one of the horizontal direction and the vertical direction, and that a unit of a size of this position error (i.e., a size of the amount of motion) is a pixel unit in the high-resolution image. In other words, it is supposed that the amount of motion between the image Fb and the image Fa is the amount of motion in the horizontal or the vertical direction of the image and that a size of the amount of motion is integer times the adjacent pixel interval of the high-resolution image. The same is true on the amount of motion between the image Fc and the image Fa.

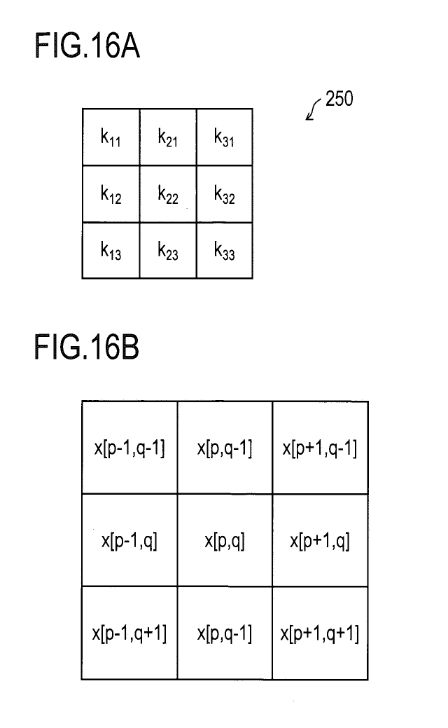

In addition, it is supposed that a point spread function (hereinafter referred to as PSF) for generating the estimated low-resolution images from the high-resolution image is made up of a filter having a 3×3 filter size (a blur filter) 250 as shown in FIG. 16A and that a normalization term (constrained term) λP^{T}Px in the evaluation function E[x] is zero. The total nine factors of the filter 250 are denoted by k₁₁, k₂₁, k₃₁, k₁₂, k₂₂, k₃₂, k₁₃, k₂₃ and k₃₃. With respect to the position to which the factor k₂₂ is assigned, the factors assigned to the upper left, the upper, the upper right, the left, the right, the lower left, the lower and the lower right positions are denoted by k₁₁, k₂₁, k₃₁, k₁₂, k₃₂, k₁₃, k₂₃ and k₃₃, respectively. Then, the noted pixel in the high-resolution image are expressed by x[p, q] as shown in FIG. 16B. Here, p and q are natural numbers. Therefore, pixels adjacent to the upper left, the upper, the upper right, the left, the right, the lower left, the lower and the lower right positions of the noted pixel x[p, q] in the high-resolution image are expressed by x[p−1, q−1], x[p, q−1], x[p+1, q−1], x[p−1, q], x[p+1, q], x[p−1, q+1], x[p, q+1] and x[p+1, q+1], respectively. In addition, for convenience sake, a pixel value of the pixel x[p, q] is also expressed by x[p, q], and the same is true on x[p−1, q−1] and the like.

Thus, when the filter 250 is exerted on the noted pixel x[p, q], the pixel value x[p−1, q−1], x[p, q−1], x[p+1, q−1], x[p−1, q], x[p, q], x[p+1, q], x[p−1, q+1], x[p, q+1] and x[p+1, q+1] are multiplied by the factors α₁₁, k₂₁, k₃₁, k₁₂, k₂₂, k₃₂, k₁₃, k₂₃ and k₃₃, respectively.

Furthermore, in symbols indicating pixel such as the noted pixel, a left symbol in a square bracket “[ ]” (e.g., p in x[p, q]) denotes a horizontal position of the pixel. The horizontal position of the pixel goes to right as a value of the symbol increases. In symbols indicating pixel such as the noted pixel, a right symbol in a square bracket “[ ]” (e.g., q in x[p, q]) denotes a vertical position of the pixel. The vertical position of the pixel goes downward as a value of the symbol increases. The same is true on the symbols ya[p, q] and the like that will be described later.

Further, it is supposed that the amount of motion between the actual low-resolution image Fa and the actual low-resolution image Fb is an amount of motion in the horizontal direction and that a size of the amount of motion corresponds to one pixel of the high-resolution image. In addition, it is supposed that the amount of motion between the actual low-resolution image Fa and the actual low-resolution image Fc is an amount of motion in the vertical direction and that a size of the amount of motion corresponds to one pixel of the high-resolution image. When the adjacent pixel interval of the actual low-resolution image is denoted by ΔS, a size of the amount of motion between the images Fa and Fb as well as a size of the amount of motion between the images Fa and Fc, which corresponds to a width of one pixel of the high-resolution image (a width in the horizontal or the vertical direction), is denoted by ΔS/2.

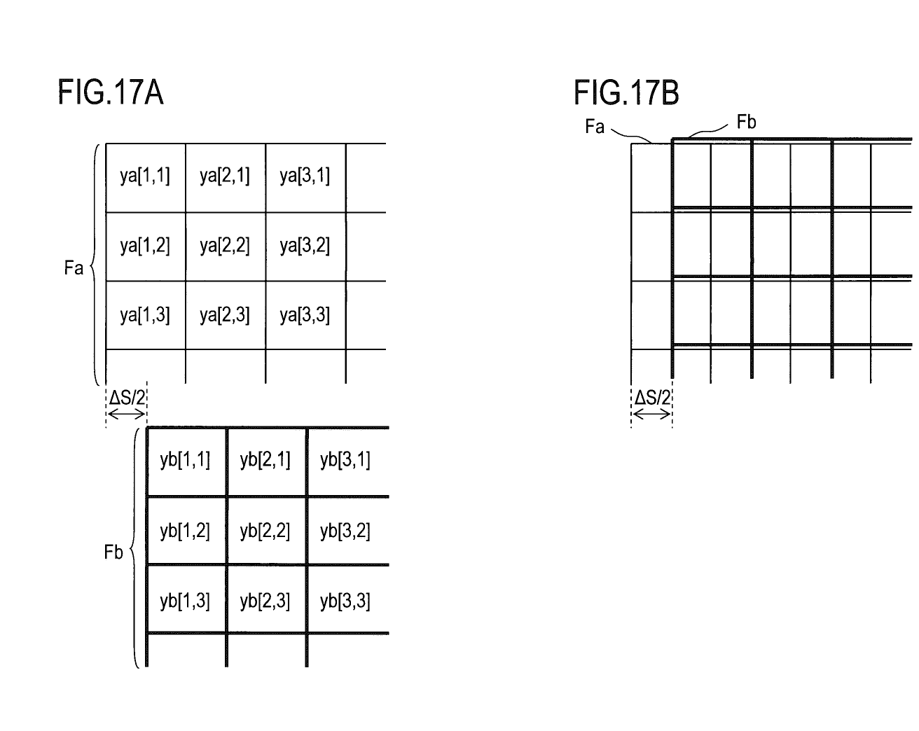

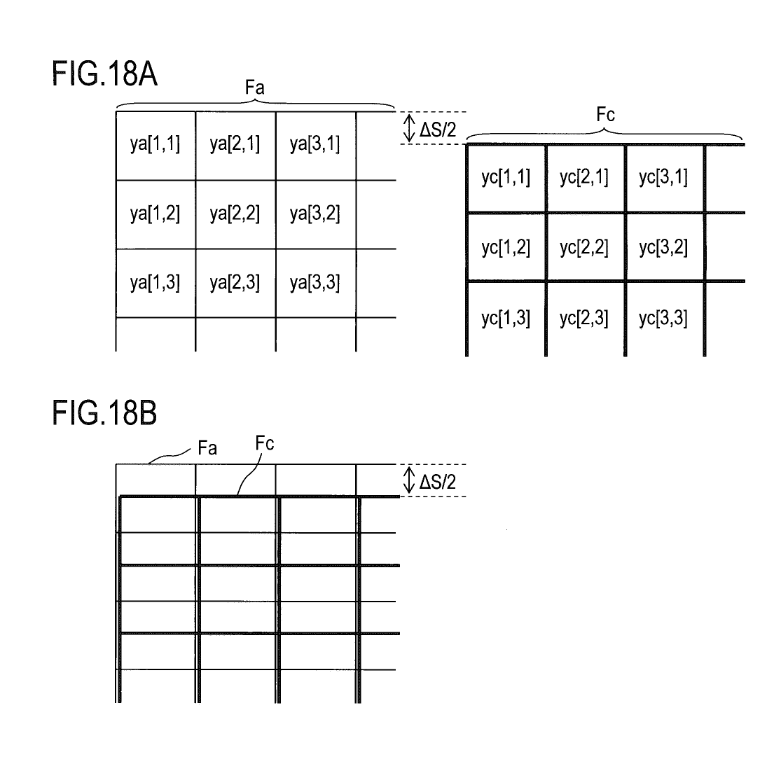

More specifically, it is supposed that the image Fb has a position error with respect to the image Fa in the horizontal direction (specifically, in the right direction) by one pixel of the high-resolution image (i.e., by ΔS/2) as shown in FIGS. 17A and 17B. In addition, it is supposed that the image Fc has a position error with respect to the image Fa in the vertical direction (specifically, in the downward direction) by one pixel of the high-resolution image (i.e., by ΔS/2) as shown in FIGS. 18A and 18B. FIG. 17A shows the images Fa and Fb in a separated manner, and FIG. 17B shows them in an overlapping manner on a common image coordinate system. However, in order to show the images Fa and Fb in a distinguishing manner in FIG. 17B, the images Fa and Fb are shifted a little from each other in the up and down direction. FIG. 18A shows the images Fa and Fc in a separated manner, and FIG. 18B shows them in an overlapping manner on a common image coordinate system. However, in order to show the images Fa and Fc in a distinguishing manner in FIG. 18B, the images Fa and Fc are shifted a little from each other in the left and right direction. Note that ya[p, q] indicates a pixel constituting the image Fa or its pixel value, and yb[p, q] indicates a pixel constituting the image Fb or its pixel value, and yc[p, q] indicates a pixel constituting the image Fc or its pixel value.

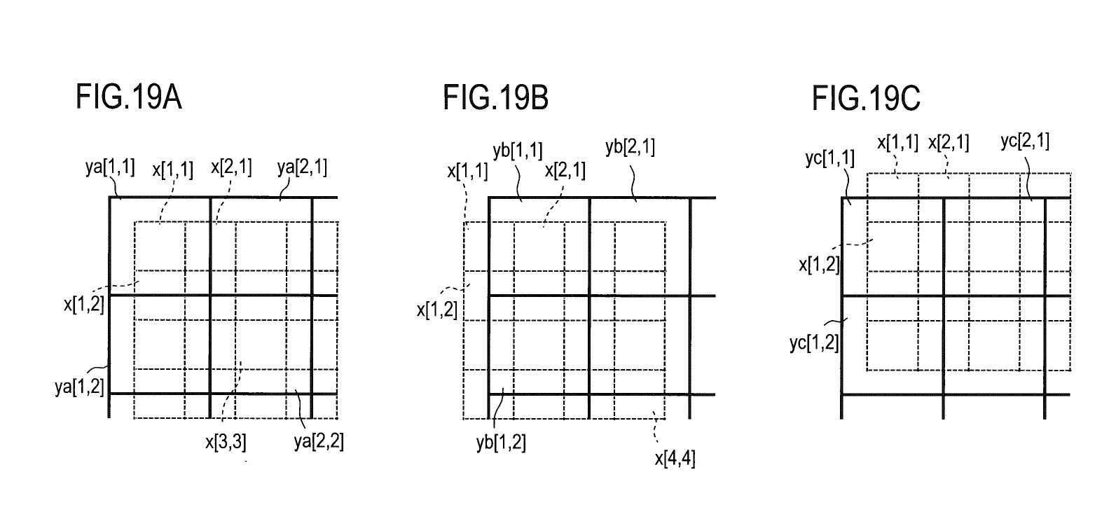

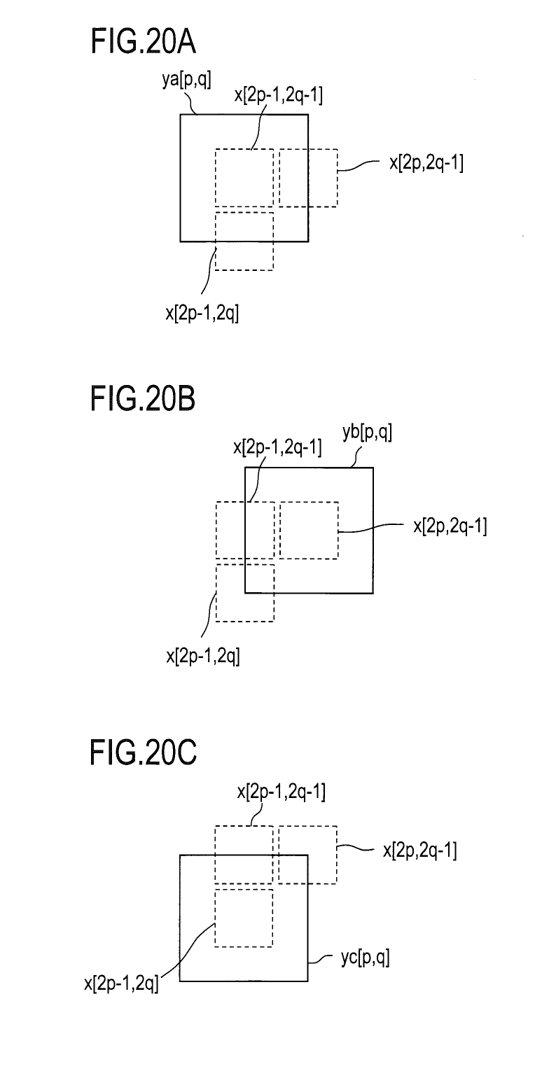

Then, if a pixel ya[1, 1] of the actual low-resolution image Fa and a pixel x[1, 1] of the initial high-resolution image Fx1 overlap with each other at their center positions as shown in FIG. 19A, a pixel yb[1, 1] of the actual low-resolution image Fb and a pixel x[2, 1] of the initial high-resolution image Fx1 overlap with each other at their center positions as shown in FIG. 19B, and a pixel yc[1, 1] of the actual low-resolution image Fc and a pixel x[1, 2] of the initial high-resolution image Fx1 overlap with each other at their center positions as shown in FIG. 19C. In addition, the center position of a pixel ya[p, q] of the image Fa agrees with the center position of a pixel x[2p−1, 2q−1] of the image Fx1 as shown in FIGS. 19A and 20A, and the center position of a pixel yb[p, q] of the image Fb agrees with the center position of a pixel x[2p, 2q−1] of the image Fx1 as shown in FIGS. 19B and 20B, and the center position of a pixel yc[p, q] of the image Fc agrees with the center position of a pixel x[2p−1, 2q] of the image Fx1 as shown in FIGS. 19C and 20C. Note that the solid line grids in FIGS. 19A, 19B and 19C indicate pixels of the images Fa, Fb and Fc respectively, and the broken line grids in FIGS. 19A, 19B and 19C indicate pixels of the high-resolution image Fx including the initial high-resolution image Fx1.

Hereinafter, it is supposed that the positional relationship between each of the pixels of the actual low-resolution images Fa, Fb and Fc and each of the pixels of the initial high-resolution image Fx1 have the relationship shown in FIGS. 19A to 19C and 20A to 20C, so that the description of the super-resolution process according to the second example will be continued.

Pixel Value Deriving Process of Estimated Low-Resolution Image (First Element Process)

A process for deriving a pixel value of the estimated low-resolution image (hereinafter also referred to as a first element process) will be described. Pixel values A[p, q], B[p, q] and C[p, q] of each of the estimated low-resolution images Fa1, Fb1 and Fc1 estimated from the initial high-resolution image Fx1 are expressed by the equations (B1) to (B3) below.

$$\begin{matrix}A [ p , q ] = {k}_{11} \cdot x [ 2 p - 2 , 2 q - 2 ] + {k}_{21} \cdot x [ 2 p - 1 , 2 q - 2 ] + {k}_{31} \cdot x [ 2 p , 2 q - 2 ] + {k}_{12} \cdot x [ 2 p - 2 , 2 q - 1 ] + {k}_{22} \cdot x [ 2 p - 1 , 2 q - 1 ] + {k}_{32} \cdot x [ 2 p , 2 q - 1 ] + {k}_{13} \cdot x [ 2 p - 2 , 2 q ] + {k}_{23} \cdot x [ 2 p - 1 , 2 q ] + {k}_{33} \cdot x [ 2 p , 2 q ] & ( B 1 ) \\ B [ p , q ] = {k}_{11} \cdot x [ 2 p - 1 , 2 q - 2 ] + {k}_{21} \cdot x [ 2 p , 2 q - 2 ] + {k}_{31} \cdot x [ 2 p + 1 , 2 q - 2 ] + {k}_{12} \cdot x [ 2 p - 1 , 2 q - 1 ] + {k}_{22} \cdot x [ 2 p , 2 q - 1 ] + {k}_{32} \cdot x [ 2 p + 1 , 2 q - 1 ] + {k}_{13} \cdot x [ 2 p - 1 , 2 q ] + {k}_{23} \cdot x [ 2 p , 2 q ] + {k}_{33} \cdot x [ 2 p + 1 , 2 q ] & ( B 2 ) \\ C [ p , q ] = {k}_{11} \cdot x [ 2 p - 2 , 2 q - 1 ] + {k}_{21} \cdot x [ 2 p - 1 , 2 q - 1 ] + {k}_{31} \cdot x [ 2 p , 2 q - 1 ] + {k}_{12} \cdot x [ 2 p - 2 , 2 q ] + {k}_{22} \cdot x [ 2 p - 1 , 2 q ] + {k}_{32} \cdot x [ 2 p , 2 q ] + {k}_{13} \cdot x [ 2 p - 2 , 2 q + 1 ] + {k}_{23} \cdot x [ 2 p - 1 , 2 q + 1 ] + {k}_{33} \cdot x [ 2 p , 2 q + 1 ] & ( B 3 )\end{matrix}$$

Gradient Deriving Process at Each Pixel of High-Resolution Image (Second Element Process)

A process for deriving a gradient at each pixel of the high-resolution image (hereinafter also referred to as a second element process) will be described. When the pixel values of the estimated low-resolution images Fa1 to Fc1 are obtained as described above, the gradient ∂E[x]/∂x with respect to the initial high-resolution image Fx1 is calculated based on a difference between the obtained pixel values and the pixel values of the actual low-resolution images Fa to Fc. Hereinafter, the calculation method of the gradient ∂E[x]/∂x in the case where the noted pixel of the high-resolution image is each of the pixels x[2p−1, 2q−1], x[2p, 2q−1] and x[2p−1, 2q] will be described individually.

First, the calculation method of the gradient ∂E[x]/∂x in the case where the noted pixel is the pixel x[2p−1, 2q−1] will be described.

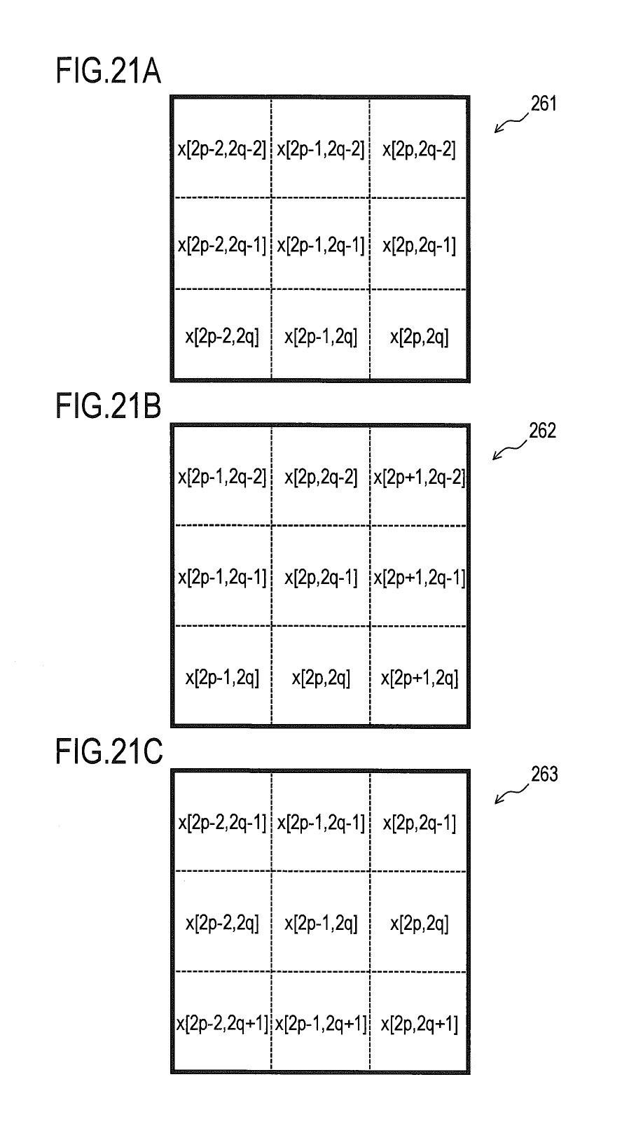

When the noted pixel is the pixel x[2p−1, 2q−1], the region 261 including 3×3 pixels x[2p−2, 2q−2] to x[2p, 2q] with the center pixel x[2p−1, 2q−1] shown in FIG. 21A is noted. Then, a filter process is performed on the region 261 using the PSF that is, so to speak, a blur function. Therefore, the gradient ∂E[x]/∂x at the pixel x[2p−1, 2q−1] is calculated by using the pixel value of the pixel having the center position in the region 261 among pixels of the actual low-resolution images Fa, Fb and Fc and the estimated low-resolution images Fa1, Fb1 and Fc1.

More specifically, the following process is performed. As understood from FIGS. 20A to 20C and the like, center positions of the pixels x[2p−1, 2q−1], x[2p, 2q−1] and x[2p−1, 2q] of the initial high-resolution image Fx1 in the region 261 agree with center positions of the pixel ya[p, q] of the image Fa, the pixel yb[p, q] of the image Fb and the pixel yc[p, q] of the image Fc, respectively. In addition, the center positions of the pixels x[2p−2, 2q−1] and x[2p−1, 2q−2] of the image Fx1 agree with the center positions of the pixel yb[p−1, q] of the image Fb and the pixel yc[p, q−1] of the image Fc, respectively. Therefore, the gradient ∂E[x]/∂x_x[2p−1, 2q−1] at the pixel x[2p−1, 2q−1] is determined in accordance with the equation (B4) below based on the pixel values ya[p, q], yb[p−1, q], yb[p, q], yc[p, q−1] and yc[p, q] of the actual low-resolution images Fa to Fc, the pixel values A[p, q], B[p−1, q], B[p, q], C[p, q−1] and C[p, q] of the estimated low-resolution images Fa1 to Fc1, and the filter 250 shown in FIG. 16A. Here, “K1=k₁₂+k₂₁+k₂₂+k₂₃+k₃₂” holds.

$$\partial E [ x ] / \partial x\_x [ 2 p - 1 , 2 q - 1 ] = {k}_{22} \cdot ( A [ p , q ] - ya [ p , q ] ) / K 1 + {k}_{12} \cdot ( B [ p - 1 , q ] - yb [ p - 1 , q ] ) / K 1 + {k}_{32} \cdot ( B [ p , q ] - yb [ p , q ] ) / K 1 + {k}_{21} \cdot ( C [ p , q - 1 ] - yc [ p , q - 1 ] ) / K 1 + {k}_{23} \cdot ( C [ p , q ] - yc [ p , q ] ) / K 1 \qquad ( B4 )$$

Second, the calculation method of the gradient ∂E[x]/∂x when the noted pixel is the pixel x[2p, 2q−1] will be described.

When the noted pixel is the pixel x[2p, 2q−1], the region 262 including 3×3 pixels x[2p−1, 2q−2] to x[2p+1, 2q] with the center pixel x[2p, 2q−1] shown in FIG. 21B is noted. Then, a filter process is performed on the region 262 by using the PSF. Therefore, the gradient ∂E[x]/∂x at the pixel x[2p, 2q−1] is calculated by using the pixel value of the pixel having the center position in the region 262 among pixels of the actual low-resolution images Fa, Fb and Fc and the estimated low-resolution images Fa1, Fb1 and Fc1.

More specifically, the following process is performed. As understood from FIGS. 20A to 20C and the like, center positions of the pixels x[2p−1, 2q−1], x[2p+1, 2q−1], x[2p, 2q−1], x[2p−1, 2q−2], x[2p−1, 2q], x[2p+1, 2q−2] and x[2p+1, 2q] of the initial high-resolution image Fx1 in the region 262 agree with center positions of the pixels ya[p, q] and ya[p+1, q] of the image Fa, the pixel yb[p, q] of the image Fb, the pixels yc[p, q−1], yc[p, q], yc[p+1, q−1] and yc[p+1, q] of the image Fc, respectively. Therefore, the gradient ∂E[x]/∂x_x[2p, 2q−1] at the pixel x[2p, 2q−1] is determined in accordance with the equation (B5) below based on the pixel values ya[p, q], ya[p+1, q], yb[p, q], yc[p, q−1], yc[p, q], yc[p+1, q−1] and yc[p+1, q] of the actual low-resolution images Fa to Fc, the pixel values A[p, q], A[p+1, q], B[p, q], C[p, q−1], C[p, q], C[p+1, q−1] and C[p+1, q] of the estimated low-resolution images Fa1 to Fc1, and the filter 250 shown in FIG. 16A. Here, “K2=k₁₂+k₂₂+k₃₂+k₁₁+k₁₃+k₃₁+k₃₃” holds.

$$\partial E [ x ] / \partial x\_x [ 2 p , 2 q - 1 ] = {k}_{22} \cdot ( B [ p , q ] - yb [ p , q ] ) / K 2 + {k}_{12} \cdot ( A [ p , q ] - ya [ p , q ] ) / K 2 + {k}_{32} \cdot ( A [ p + 1 , q ] - ya [ p + 1 , q ] ) / K 2 + {k}_{11} \cdot ( C [ p , q - 1 ] - yc [ p , q - 1 ] ) / K 2 + {k}_{13} \cdot ( C [ p , q ] - yc [ p , q ] ) / K 2 + {k}_{31} \cdot ( C [ p + 1 , q - 1 ] - yc [ p + 1 , q - 1 ] ) / K 2 + {k}_{33} \cdot ( C [ p + 1 , q ] - yc [ p + 1 , q ] ) / K 2 \qquad ( B5 )$$

Third, the calculation method of the gradient ∂E[x]/∂x when the noted pixel is the pixel x[2p−1, 2q] will be described.

When the noted pixel is the pixel x[2p−1, 2q], the region 263 including 3×3 pixels x[2p−2, 2q−1] to x[2p, 2q+1] with the center pixel x[2p−1, 2q] shown in FIG. 21C is noted. Then, a filter process is performed on the region 263 by using the PSF. Therefore, the gradient ∂E[x]/∂x at the pixel x[2p−1, 2q] is calculated by using the pixel value of the pixel having the center position in the region 263 among pixels of the actual low-resolution images Fa, Fb and Fc and the estimated low-resolution images Fa1, Fb1 and Fc1.

More specifically, the following process is performed. As understood from FIGS. 20A to 20C and the like, center positions of the pixels x[2p−1, 2q−1], x[2p−1, 2q+1], x[2p−2, 2q−1], x[2p, 2q−1], x[2p−2, 2q+1], x[2p, 2q+1] and x[2p+1, 2q] of the initial high-resolution image Fx1 in the region 263 agree with center positions of the pixels ya[p, q] and ya[p, q+1] of the image Fa, the pixels yb[p−1, q], yb[p, q], yb[p−1, q+1] and yb[p, q+1] of the image Fb, and the pixel yc[p, q] of the image Fc, respectively. Therefore, the gradient ∂E[x]/∂x_x[2p−1, 2q] at the pixel x[2p−1, 2q] is determined in accordance with the equation (B6) below based on the pixel values ya[p, q], ya[p, q+1], yb[p−1, q], yb[p, q], yb[p−1, q+1], yb[p, q+1] and yc[p, q] of the actual low-resolution images Fa to Fc, the pixel values A[p, q], A[p, q+1], B[p−1, q], B[p, q], B[p−1, q+1], B[p, q+1] and C[p, q] of the estimated low-resolution images Fa1 to Fc1, and the filter 250 shown in FIG. 16A. Here, “K3=k₂₁+k₂₂+k₂₃+k₁₁+k₁₃+k₃₁+k₃₃” holds.

$$\partial E [ x ] / \partial x\_x [ 2 p - 1 , 2 q ] = {k}_{22} \cdot ( C [ p , q ] - yc [ p , q ] ) / K 3 + {k}_{21} \cdot ( A [ p , q ] - ya [ p , q ] ) / K 3 + {k}_{23} \cdot ( A [ p , q + 1 ] - ya [ p , q + 1 ] ) / K 3 + {k}_{11} \cdot ( B [ p - 1 , q ] - yb [ p - 1 , q ] ) / K 3 + {k}_{31} \cdot ( B [ p , q ] - yb [ p , q ] ) / K 3 + {k}_{13} \cdot ( B [ p - 1 , q + 1 ] - yb [ p - 1 , q + 1 ] ) / K 3 + {k}_{33} \cdot ( B [ p , q + 1 ] - yb [ p , q + 1 ] ) / K 3 \qquad ( B6 )$$

Pixel Value Updating Process of Each Pixel of High-Resolution Image (Third Element Process)

A process for updating the pixel value of each pixel of the high-resolution image (hereinafter referred to as a third element process) will be described. After the gradient ∂E[x]/∂x at each pixel of the high-resolution image is calculated as described above, the calculated gradient is subtracted from the pixel value of the initial high-resolution image so that a pixel value of the updated high-resolution image can be calculated. In other words, the pixel value at the pixel x[p, q] is updated by using the gradient ∂E[x]/∂x_x[p, q] at the pixel x[p, q], so that the pixel value at the pixel x1[p, q] in the high-resolution image Fx2 can be calculated. The symbol x1[p, q] indicates a pixel constituting the image Fx2 or its pixel value. Furthermore, “x1[p, q]=x[p, q]−∂E[x]/∂x_x[p, q]” holds.

When the first to the third element processes described above are performed, the high-resolution image is updated. In the second update, the pixel values of the estimated low-resolution images Fa2 to Fc2 is determined in the first element process based on the above equations (B1) to (B3). On this occasion, instead of the pixel values (x[2p, 2q] and the like) of the high-resolution image Fx1, the pixel values (x1[2p, 2q] and the like) of the high-resolution image Fx2 are used. More specifically, the pixel values of the estimated low-resolution images Fa2, Fb2 and Fc2 are expressed by the equations (B7) to (B9) below, respectively. Similarly to the images Fa1, Fb1 and Fc1, the pixel values of the images Fa2, Fb2 and Fc2 are also expressed by A [p, q], B[p, q] and C[p, q] for convenience sake.

$$\begin{matrix}A [ p , q ] = {k}_{11} \cdot x 1 [ 2 p - 2 , 2 q - 2 ] + {k}_{21} \cdot x 1 [ 2 p - 1 , 2 q - 2 ] + {k}_{31} \cdot x 1 [ 2 p , 2 q - 2 ] + {k}_{12} \cdot x 1 [ 2 p - 2 , 2 q - 1 ] + {k}_{22} \cdot x 1 [ 2 p - 1 , 2 q - 1 ] + {k}_{32} \cdot x 1 [ 2 p , 2 q - 1 ] + {k}_{13} \cdot x 1 [ 2 p - 2 , 2 q ] + {k}_{23} \cdot x 1 [ 2 p - 1 , 2 q ] + {k}_{33} \cdot x 1 [ 2 p , 2 q ] & ( B 7 ) \\ B [ p , q ] = {k}_{11} \cdot x 1 [ 2 p - 1 , 2 q - 2 ] + {k}_{21} \cdot x 1 [ 2 p , 2 q - 2 ] + {k}_{31} \cdot x 1 [ 2 p + 1 , 2 q - 2 ] + {k}_{12} \cdot x 1 [ 2 p - 1 , 2 q - 1 ] + {k}_{22} \cdot x 1 [ 2 p , 2 q - 1 ] + {k}_{32} \cdot x 1 [ 2 p + 1 , 2 q - 1 ] + {k}_{13} \cdot x 1 [ 2 p - 1 , 2 q ] + {k}_{23} \cdot x 1 [ 2 p , 2 q ] + {k}_{33} \cdot x 1 [ 2 p + 1 , 2 q ] & ( B 8 ) \\ C [ p , q ] = {k}_{11} \cdot x 1 [ 2 p - 2 , 2 q - 1 ] + {k}_{21} \cdot x 1 [ 2 p - 1 , 2 q - 1 ] + {k}_{31} \cdot x 1 [ 2 p , 2 q - 1 ] + {k}_{12} \cdot x 1 [ 2 p - 2 , 2 q ] + {k}_{22} \cdot x 1 [ 2 p - 1 , 2 q ] + {k}_{32} \cdot x 1 [ 2 p , 2 q ] + {k}_{13} \cdot x 1 [ 2 p - 2 , 2 q + 1 ] + {k}_{23} \cdot x 1 [ 2 p - 1 , 2 q + 1 ] + {k}_{33} \cdot x 1 [ 2 p , 2 q + 1 ] & ( B 9 )\end{matrix}$$

After the pixel values of the estimated low-resolution images Fa2 to Fc2 are determined, the gradient a E[x1]/∂x with respect to each pixel in the high-resolution image is calculated based on the above equations (B4) to (B6). Then, this gradient a E[x1]/∂x is subtracted from the pixel value of the high-resolution image Fx2 so that the second updating process is performed for generating the high-resolution image Fx3.

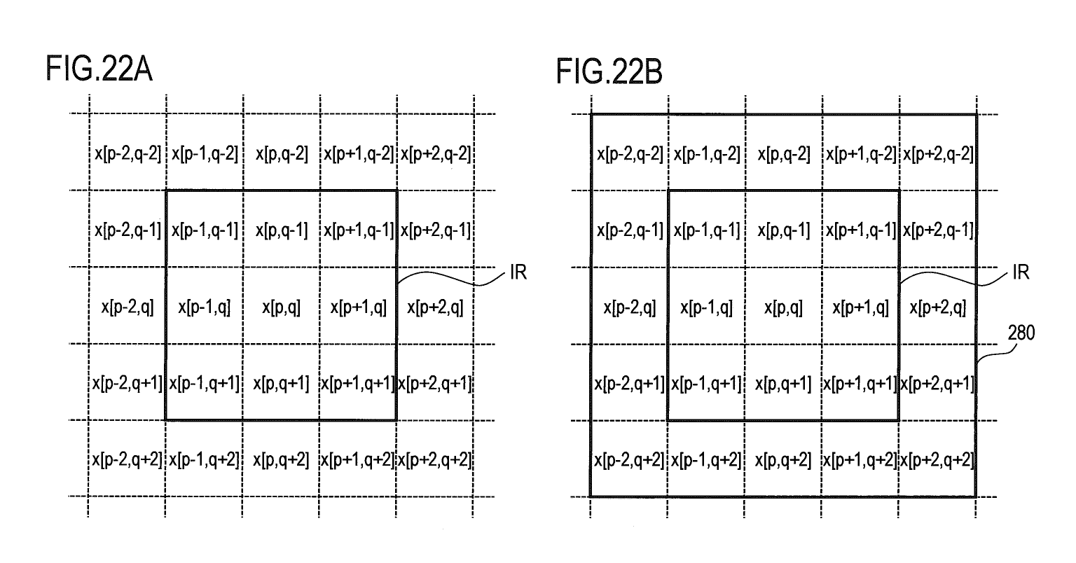

As described above, when the calculation process is performed by using the PSF expressed in a 3×3 matrix, the image region IR shown in FIG. 22A is noted with respect to one noted pixel x[p, q] on the initial high-resolution image Fx1 in the action of the first updating process. The image region IR is made up of 3×3 pixels x[p−1, q−1] to x[p+1, q+1] with the center pixel that is the noted pixel x[p, q]. Then, pixel values of the pixels of the actual low-resolution images and the estimated low-resolution images, which are positioned in the image region IR, are necessary. Hereinafter, an image region like the image region IR made up of 3×3 pixels with the center pixel that is a certain pixel (noted pixel) concerning the high-resolution image is referred to as a reference image region.

Further, the pixel value of the estimated low-resolution image can be obtained by substituting pixel values of the 3×3 pixels of the initial high-resolution image Fx1 into the PSF as described above. On the other hand, the pixel values of the 3×3 pixels of the initial high-resolution image Fx1 are used for obtaining the pixel value of the pixel on the estimated low-resolution image, which is located at the pixel position other than the noted pixel x[p, q] in the reference image region IR. Therefore, in the action of the first updating process, 5×5 pixels x[p−2, q−2] to x[p+2, q+2] of the initial high-resolution image Fx1 located at a position inside a frame 280 shown in FIG. 22B are used.

More specifically, in order to generate the high-resolution image Fx2 by updating the initial high-resolution image Fx1 only once, pixel values of 5×5 pixels x[p−2, q−2] to x[p+2, q+2] of the initial high-resolution image Fx1 are necessary for the noted pixel x[p, q] in the initial high-resolution image Fx1. In addition, the reference image region made up of 3×3 pixels x1[p−1, q−1] to x1[p+1, q+1] of the initial high-resolution image Fx1 is noted, and pixel values of the pixels of the actual low-resolution images Fa to Fc positioned in the reference image region are necessary.

When the high-resolution image Fx2 obtained by the update of one time is further updated, the process is performed by using the pixel values after the update. More specifically, pixel values of 5×5 pixels x1[p−2, q−2] to x1[p+2, q+2] of the high-resolution image Fx2 are necessary for the noted pixel x1[p, q] in the high-resolution image Fx2. In addition, the reference image region made up of 3×3 pixels x1[p−1, q−1] to x1[p+1, q+1] of the high-resolution image Fx2 is noted, and pixel values of the pixels of the actual low-resolution images Fa to Fc positioned in the reference image region are necessary.

However, when the high-resolution image Fx2 is obtained from the initial high-resolution image Fx1 by updating the pixel value, pixel values of 5×5 pixels of the initial high-resolution image Fx1 and pixel values of the pixels of the actual low-resolution images Fa to Fc positioned in the reference image region of the initial high-resolution image Fx1 are necessary for each pixel. More specifically, the pixel values of 5×5 pixels x1[p−2, q−2] to x1[p+2, q+2] of the high-resolution image Fx2 that are used for the noted pixel x1[p, q] in the high-resolution image Fx2 are calculated in the first updating process by using pixel values of the 5×5 pixels of the initial high-resolution image Fx1 and pixel values of the pixels of the actual low-resolution images Fa to Fc positioned in the reference image region of the initial high-resolution image Fx1.

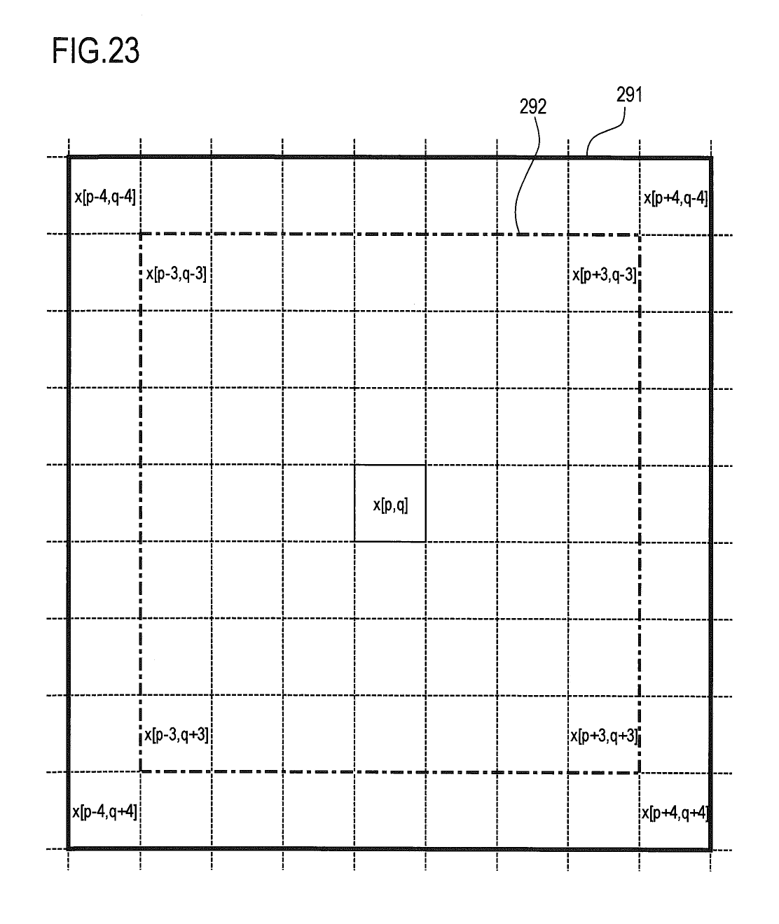

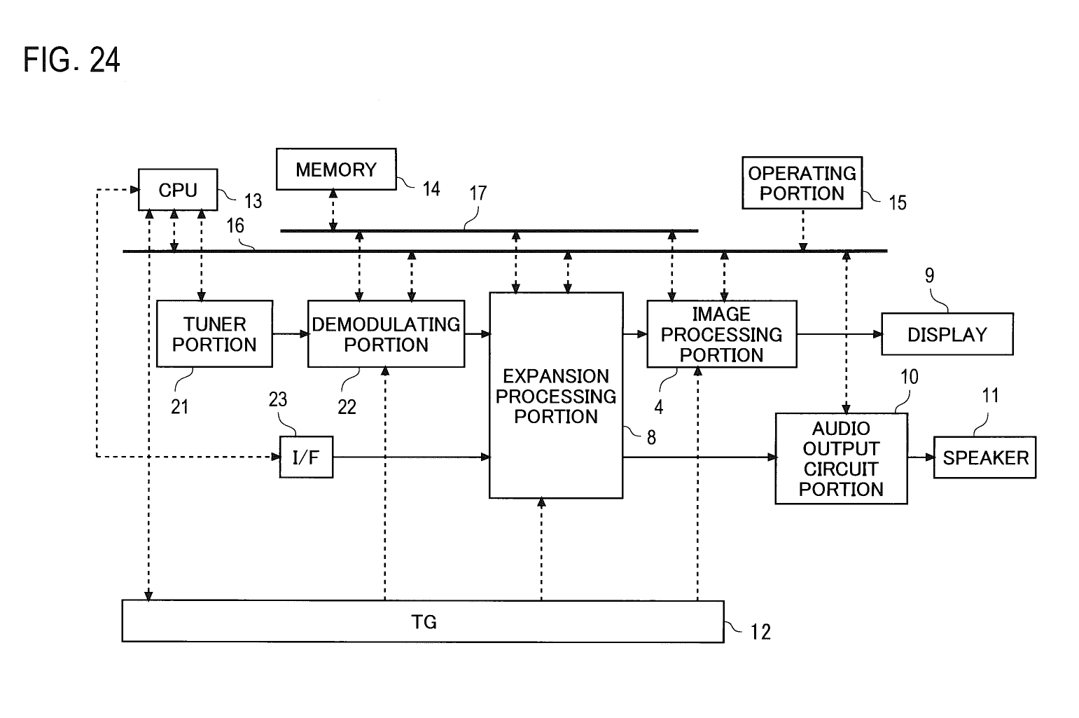

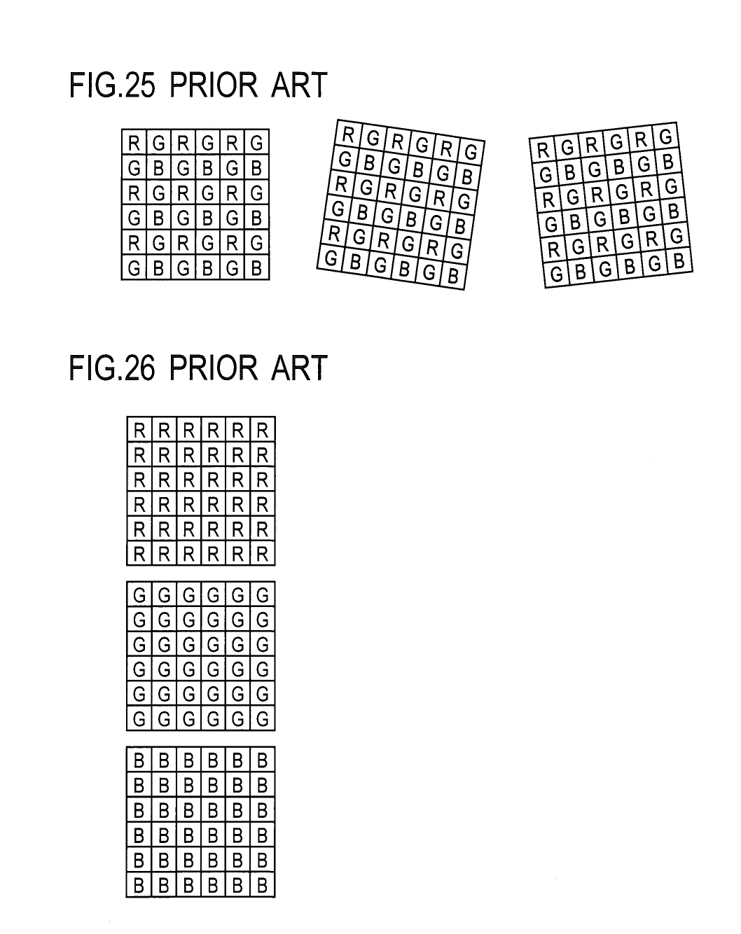

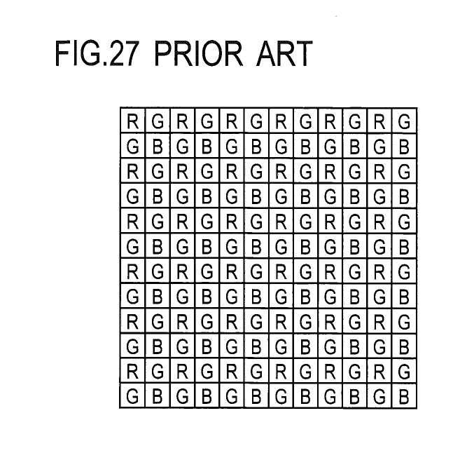

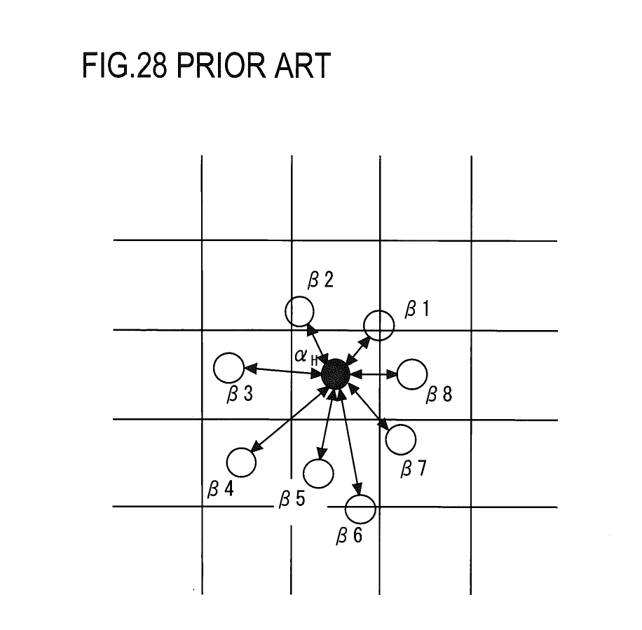

Therefore, if the initial high-resolution image Fx1 is updated two times, the noted pixel x[p, q] is further updated by using the updated pixel values of the 5×5 pixels x[p−2, q−2] to x[p+2, q+2]. In other words, this updating process is performed by using pixel values of 5×5 pixels of the initial high-resolution image Fx1 with the center pixel that is each of the 5×5 pixels x[p−2, q−2] to x[p+2, q+2]. Further, in this updating process, reference image regions of the initial high-resolution image Fx1 when each of the 5×5 pixels x[p−2, q−2] to x[p+2, q+2] is regarded as the noted pixel (total 25 reference image regions) are noted, and pixel values of the pixels of the actual low-resolution images Fa to Fc positioned in their reference image regions are also used. Therefore, if the initial high-resolution image Fx1 is updated two times, pixel values of 9×9 pixels x[p−4, q−4] to x[p+4, q+4] of the initial high-resolution image Fx1 positioned in the solid line frame 291 shown in FIG. 23 are necessary for the noted pixel x[p, q] in the initial high-resolution image Fx1. In addition, pixel values of the pixels of the actual low-resolution images Fa to Fc positioned in the image region enclosed by the dashed dotted line frame 292 shown in FIG. 23 are also necessary. The image region enclosed by the dashed dotted line frame 292 is also denoted by the numeral 292. The image region 292 is made up of 7×7 pixels x[p−3, q−3] to x[p+3, q+3] of the initial high-resolution image Fx1.

Therefore, the FIR filter constituting the filter portion 47 shown in FIG. 10 is formed as a filter that receives “pixel values of 9×9 pixels of the initial high-resolution image Fx1” and “pixel values of the pixels of the actual low-resolution images Fa to Fc positioned in the image region 292 of the initial high-resolution image Fx1” as input values, and that outputs the pixel value of the noted pixel.

Factors of this FIR filter can be obtained as described below. First, the pixel values of the estimated low-resolution images obtained based on the above equations (B1) to (B3) are substituted into the equations (B4) to (B6) so that the gradient is determined. After that, the pixel values of the high-resolution image updated by the gradient based on the equations (B4) to (B6) are substituted into equations (B7) to (B9), and the obtained pixel values of the estimated low-resolution image are substituted into the equations (B4) to (B6) so that the new gradient (the second gradient) is determined. Then, expanding a subtract equation for updating the high-resolution image by using the new gradient, factors by which the “pixel values of 9×9 pixels of the initial high-resolution image Fx1” and the “pixel values of the pixels of the actual low-resolution images Fa to Fc positioned in the image region 292 of the initial high-resolution image Fx1” are multiplied, are determined. The determined factors can be obtained as the factors of the FIR filter.

Although it is supposed that an amount of motion with a pixel unit of the high-resolution image is generated between different actual low-resolution images in the above description, it is possible that an amount of motion with a sub pixel unit of the high-resolution image may be generated between them.

Furthermore, although the update quantity when the updating action that is repeated in the above-mentioned reconstruction type super-resolution process is performed two times is calculated in this example, it is possible to adopt the structure in which the update quantity when the updating action is repeated three times or more is calculated. For instance, it is supposed that the update quantity when the updating action in the super-resolution process is repeated H_{A} times is calculated, and that the PSF that is, so to speak, a blur function is made up of (2−K_{A}+1)×(2−K_{A}+1) matrix. Here, H_{A} is an integer of three or more, and K_{A} is a natural number. In this case, the FIR filter constituting the filter portion 47 shown in FIG. 10 is formed as a filter that receives “pixel values of the pixels (4H_{A}×K_{A}+1)×(4H_{A}×K_{A}+1) of the initial high-resolution image Fx1” and “pixel values of the pixels of the actual low-resolution images Fa to Fc positioned in the image region 295 of the initial high-resolution image Fx1” as input values, and that outputs the pixel value of the noted pixel. Here, the image region 295 is made up of pixels (2(2H_{A}−1)×K_{A}+1)×(2(2H_{A}−1)×K_{A}+1) of the initial high-resolution image Fx1. Note that the image region 295 is not shown in the drawings.

### THIRD EXAMPLE

Next, a third example of the present invention will be described. Although the image sensing apparatus having the structure shown in FIG. 1 is exemplified in the above description of the image processing method according to the present invention, this image processing method can be used not only for the image sensing apparatus but also for a display device such as a liquid crystal display or a plasma television set that performs digital image processing. FIG. 24 illustrates a display device equipped with the image processing apparatus (corresponding to the image processing portion) performing the image processing method according to the present invention. FIG. 24 is a general block diagram of this display device.

The display device shown in FIG. 24 includes an image processing portion 4, an expansion processing portion 8, a display portion 9, an audio output circuit portion 10, a speaker portion 11, a timing generator 12, a CPU 13, a memory 14, an operating portion 15 and bus lines 16 and 17 similarly to the image sensing apparatus shown in FIG. 1. In addition, the display device shown in FIG. 24 includes a tuner portion 21 for selecting a broadcasting signal received externally, a demodulating portion 22 for demodulating the broadcasting signal selected by the tuner portion 21, and an interface 23 for receiving a digital compressed signal supplied from the outside. The compressed signal received by the interface 23 includes a compressed and coded image signal indicating a moving image or a still image. As the image processing portion 4 of the display device shown in FIG. 24, the image processing portion 4 described above in the first or the second example is used, for instance.

When the display device shown in FIG. 24 receives a broadcasting signal, a broadcasting signal of a desired channel is selected by the tuner portion 21. Then, the demodulating portion 22 demodulates the selected broadcasting signal, so that a digital signal as a compressed signal by the MPEG compression method is obtained. The compressed signal obtained from the broadcasting signal includes the compressed and coded image signal indicating a moving image or a still image. The expansion processing portion 8 performs an expansion process by the MPEG compression method on the compressed signal received by the interface 23 or the compressed signal obtained by the demodulating portion 22. The image signal obtained by the expansion process in the expansion processing portion 8 is supplied to the image processing portion 4 as an image signal of an actual low-resolution image sequence arranged in time series. In other words, the image signal of a plurality of actual low-resolution images arranged in time series are supplied to the image processing portion 4 sequentially one by one frame.

Then, when an operation requesting the high resolution processing of the image is performed by the operating portion 15, the image processing portion 4 shown in FIG. 24 performs the above-mentioned selection process of the actual low-resolution image and the super-resolution process on the supplied actual low-resolution image sequence, so that the high-resolution image is generated. The image signal indicating the generated high-resolution image is supplied to the display portion 9 so that image reproduction including reproduction of the high-resolution image is performed. In addition, an audio signal obtained by the expansion process in the expansion processing portion 8 is supplied to the speaker portion 11 via the audio output circuit portion 10, so that sounds are reproduced and output.

In addition, as to the image sensing apparatus shown in FIG. 1 or the display device shown in FIG. 24, the image on which the image processing portion 4 performs the super-resolution process may be a moving image or a still image. The examples of action in the above description are described mainly about the action when the image signal of a moving image is supplied to the image processing portion 4.

The present invention can be applied to an electronic appliance (e.g., an image sensing apparatus or a display device) equipped with the image processing apparatus performing the high resolution processing of an image by the super-resolution process.

According to the present invention, the image region of the actual low-resolution image is divided into relatively small regions, and the high resolution processing is performed for each of the regions obtained by the division. Therefore, the number of factors in the calculation equation for performing the high resolution processing can be reduced compared with the conventional method in which the high resolution processing is performed on all the pixels of the actual low-resolution image at one time. As a result, setting of the factors in the calculation equation can be facilitated, and a quantity of the calculation for the high resolution processing can be reduced. In addition, when a filter is used for performing the high resolution processing, setting of the filter factor can be facilitated.

In addition, when a super-resolution target region is set for each of the actual low-resolution images so as to obtain pixel values of the high-resolution image from a plurality of actual low-resolution images, it is possible to make the image processing apparatus store the filter factors based on a positional relationship between the super-resolution target regions since the number of the filter factors to be set can be reduced. If the filter factors stored in this way are used for performing the filter process, it is possible to perform the high resolution processing of an image easily at a high speed.

What is claimed is:

1. An image processing apparatus comprising:
a high resolution processing portion for generating a high-resolution image from a first low-resolution image to be a datum frame and M (M is an integer of one or larger) second low-resolution images, the high-resolution image having a higher resolution than the low-resolution images; and
a region cutting out portion for setting a first target region in an image region of the first low-resolution image and for setting a second target region in an image region of the second low-resolution image, wherein
the high resolution processing portion calculates a pixel value of a region corresponding to the first target region in an image region of the high-resolution image based on pixel values of the first and the second target regions set by the region cutting out portion, and
the region cutting out portion scans a position of the first target region to be set in the first low-resolution image and sets the second target region at a position corresponding to the position of the first target region after the scan every time when the high resolution processing portion calculates the pixel value of the high-resolution image.

2. The image processing apparatus according to claim 1, wherein
the integer M is one,
the image processing apparatus further includes a motion amount calculation portion for calculating an amount of motion between the first low-resolution image and the second low-resolution image, and
the region cutting out portion sets the position of the second target region based on the amount of motion.

3. The image processing apparatus according to claim 1, wherein
the integer M is two or larger,
the image processing apparatus further includes a motion amount calculation portion for calculating an amount of motion between the first low-resolution image and the second low-resolution image for each of the second low-resolution images, and
the region cutting out portion sets the position of the second target region based on the amount of motion for each of the second low-resolution images.

4. The image processing apparatus according to claim 1, wherein
the high resolution processing portion is made up of a filter for calculating the pixel value of the high-resolution image from pixel values of the first and the second target regions, and
a filter factor of the filter is updated based on a positional relationship between the first and the second target regions set by the region cutting out portion every time when the position of the first target region is scanned.

5. The image processing apparatus according to claim 4, wherein
the positional relationship is classified into a plurality of types of positional relationships,
the image processing apparatus further includes a filter factor storage portion for storing a filter factor of the filter for each of the types of the positional relationships, and
a filter factor corresponding to the positional relationship between the first and the second target regions set by the region cutting out portion is read out from the filter factor storage portion, so that the read-out filter factor is set as the filter factor of the filter constituting the high resolution processing portion.

6. An electronic appliance having an image processing apparatus and obtaining (M+1) images as an external input or by exposure so that an image signal of the (M+1) images is supplied to the image processing apparatus, wherein
an image processing apparatus according to claim 1 is used as the image processing apparatus, and
the (M+1) images include the first low-resolution image and the M second low-resolution images.

7. An image processing method comprising:
a high resolution processing step for generating a high-resolution image from a first low-resolution image to be a datum frame and M (M is an integer of one or larger) second low-resolution images, the high-resolution image having a higher resolution than the low-resolution images; and
a region cutting out step for setting a first target region in an image region of the first low-resolution image and for setting a second target region in an image region of the second low-resolution image, wherein
the high resolution processing step includes calculating a pixel value of a region corresponding to the first target region in an image region of the high-resolution image based on pixel values of the first and the second target regions set by the region cutting out step, and
the region cutting out step includes scanning a position of the first target region to be set in the first low-resolution image and setting the second target region at a position corresponding to the position of the first target region after the scan every time when the pixel value of the high-resolution image is calculated in the high resolution processing step.
